(19) United States
(12) Patent Application Publication
(10) Pub. No.: US 2006/0245640 A1
(43) Pub. Date: Nov. 2, 2006

(54) Methods and apparatus of image processing using drizzle filtering

(76) Inventor: Steven J. Szczuka, Chino Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/118,972

(22) Filed: Apr. 28, 2005

(51) Int. Cl. G06K 9/00

(52) U.S. Cl. 382/154

(57) ABSTRACT

In various embodiments of the invention, optical imaging systems such as a telescope utilize a method of forming a virtual image by processing multiple images from the telescope, the virtual image comprising an array of pixels, the method comprising capturing an image comprising an array of pixels using the telescope, the pixels in the array of pixels having associated pixel magnitudes, changing pixels of the virtual image based on the pixel magnitudes of the captured image using a drizzle algorithm, adjusting an imaging control parameter after the changing step, and repeating the capturing and changing steps after adjusting the imaging control parameter.

### BACKGROUND OF THE INVENTION

1. Field of the Invention

The present invention relates to image processing, and in particular, to image processors and methods of image processing that can be employed, for example, to reduce blur.

2. Description of the Related Art

Astronomical telescopes that enable optical imaging of celestial objects such as the moon, planets, and stars, can be outfitted with electronic detector arrays disposed at a focal plane for the telescope to record images of these heavenly objects. The detector array comprises a plurality of detectors that outputs an electrical signal in response to illumination. The outputs from the plurality of detectors (the detectors individually being referred to as pixels) together reconstruct the image. The electrical output may be transferred electronically to memory such as RAM or a storage device.

Images of celestial objects when obtained from earth commonly are blurred as a result of atmospheric effects such as fluctuations in the refraction index of the atmosphere, which changes with time, temperature, location, and altitude. These fluctuations in refractive index alter the propagation of light in an irregular and unpredictable manner and result in image degradation. Additionally, the relatively lower sensitivity of reasonably affordable detector arrays inhibits recording images of desired faint celestial objects.

What is needed, therefore, are apparatus and methods for recording faint celestial objects and reducing image degradation resulting from atmospheric effects.

### SUMMARY OF THE INVENTION

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One embodiment of the invention includes a method of forming a virtual image by processing multiple images from a telescope, the virtual image comprising an array of pixels, the method comprising capturing an image comprising an array of pixels using the telescope, the pixels in the array of pixels having associated pixel magnitudes, changing pixels of the virtual image based on the pixel magnitudes of the captured image using a drizzle algorithm, adjusting an imaging control parameter after the changing step, and repeating the capturing and changing steps after adjusting the imaging control parameter. In one aspect of the first embodiment, the imaging control parameter is adjusted based on information from the captured image. In a second aspect, the imaging control parameter is adjusted based on information from the virtual image. In a third aspect, the pixels in the captured image have a larger size than the pixels in the virtual image. In a fourth aspect, changing pixels of the virtual image using the drizzle algorithm comprises associating the array of pixels of the captured image with an array of regions of smaller size, respective pixel magnitudes for the array of pixels of the captured image being associated with corresponding regions in said array of regions, and distributing portions from the pixel magnitudes into the pixels in the virtual image, the distribution being based on overlap of the regions with the pixels of the virtual image. In a fifth aspect, the imaging control parameter comprises gain, DC offset, exposure time, focus, or position. In a sixth aspect, the method further comprises repositioning the telescope so that the captured image overlaps a portion of the virtual image that was not included in previously captured images. In a seventh aspect, repositioning the telescope comprises positioning the telescope so that the captured image overlaps a portion of the virtual image that was included in previously captured images. In an eighth aspect, the method further comprises repositioning the telescope so that the captured image is translated an amount comprising more than twice the pitch of the pixels for the captured images. In a ninth aspect, the telescope is translated an amount between about one-tenth ( 1/10) of a pixel and three-quarters (¾) of a length dimension of the virtual image. In a tenth aspect of the first embodiment, the method further comprises evaluating the quality of the captured image before including pixel magnitudes from the captured image in the virtual image. In an eleventh aspect, evaluating the quality of the captured image comprises comparing one or more characteristics of the captured image to one or more criteria, and rejecting the image if the one or more characteristics do not meet the corresponding criteria. In a twelfth aspect, the characteristic comprises sharpness, distortion, or smearing. In a thirteenth aspect, one or more of the criteria are dynamically determined.

Another embodiment of the invention includes a telescope system for generating enhanced images, comprising a telescope, a camera comprising a detector array disposed to capture images formed by the telescope, the captured images comprising arrays of pixels with associated pixel magnitudes, and at least one processor in communication with the camera and the telescope, the processor configured to define a virtual image comprising pixels, receive a first captured image from the detector array, change pixels of the virtual image based on the pixel magnitudes of the first captured image using a drizzle algorithm, adjust an imaging control parameter after changing the pixels of the virtual image, receive a second captured image from the detector array, and change pixels of the virtual image based on the pixel magnitudes of the second captured image using a drizzle algorithm after adjusting the imaging control parameter. In one aspect of the second embodiment, the processor is further configured to reposition the telescope using information from the first captured image to determine the position of the telescope for the second captured image. In a second aspect, the processor is further configured to evaluate the captured image before including pixel magnitudes from the captured image in the virtual image.

Another embodiment includes a method of forming an enlarged virtual image by processing multiple images from a telescope, the enlarged virtual image comprising an array of pixels, the method comprising capturing a first image comprising a first array of pixels using the telescope, the pixels in the first array of pixels having respective pixel magnitudes, capturing a second image comprising a second array of pixels using the telescope, the pixels in the second array of pixels having respective pixel magnitudes, moving the telescope prior to capturing the second image to introduce a shift between the first and second captured images that is at least as large as about 1/10 of the size of the first captured image, and changing pixels of the virtual image based on the pixel magnitudes of the first and second captured image using a drizzle algorithm. In one aspect of the third embodiment, the telescope is moved such that the second captured image is shifted by at least about one-tenth ( 1/10) to about ten (10) times the size of a length dimension of the first captured image. In a second aspect, the method further comprises moving the telescope and capturing images a plurality of times prior to capturing the second image. In a third aspect, the telescope is moved and images are captured between 1 and 100 times after capturing the first image and prior to capturing the second image. In a fourth aspect, the first array of pixels have a pixel pitch, and the telescope is moved sufficiently to provide a shift between captured images at least as much as about twice the pixel pitch. In a fifth aspect, the enlarged virtual image is at least about 100 to 1000 percent as large at the first captured image. In a sixth aspect, the virtual image is changed based on the pixel magnitudes of the first captured image prior to capturing the second image.

Another embodiment includes a system for generating enhanced images, comprising a telescope including a movable positioning system, a camera comprising a detector array disposed to capture images formed by the telescope, the captured images comprising arrays of pixels with associated pixel magnitudes, and at least one processor in communication with the detector array and positioning system, the processor configured to define a virtual image comprising pixels, capture a first image, capture a second image, move the telescope prior to capturing the second image to introduce a shift between the first and second captured images that is at least as large as about 1/10 of the size of the first captured image, and change pixels of the virtual image based on the pixel magnitudes of the first and second captured image using a drizzle algorithm.

Another embodiment includes a system that produces a virtual image by processing multiple images from a telescope, the virtual image comprising an array of pixels, the system comprising means for capturing an image formed by the telescope where the image comprises an array of pixels having a pixel magnitude, means for changing pixels of the virtual image based on the pixel magnitudes of the captured image using a drizzle algorithm, and means for adjusting an imaging control parameter after changing pixels of the virtual image. The means for capturing and said means for changing are configured to repeat the capturing and changing steps after adjustment of the imaging control parameter.

Another embodiment includes a computer-readable storage medium containing a set of instructions for a computer for forming a virtual image by processing multiple images from a telescope, the virtual image comprising an array of pixels, the set of instructions comprising capturing an image comprising an array of pixels using the telescope, the pixels in the array of pixels having respective pixel magnitudes, changing pixels of the virtual image based on the pixel magnitudes of the captured image using a drizzle algorithm, adjusting an imaging control parameter after changing pixels of the virtual image, and repeating the capturing and changing steps after adjusting the imaging control parameter.

### BRIEF DESCRIPTION OF THE DRAWINGS

FIGS. 1 and 2 are different views of a telescope having a CMOS camera attached thereto for recording images of distant objects.

FIG. 3 is a digital image of a planet obtained using a telescope and CMOS camera such as shown in FIGS. 1 and 2.

FIG. 4 is a block diagram illustrating one embodiment of an imaging system that includes a CMOS detector array and an image processor.

FIG. 5 is a block diagram illustrating an embodiment of an imaging system that includes a CMOS detector array and an image processor comprising a computer.

FIG. 6 is a flow chart illustrating a method of processing a plurality of images to yield an improved composite image.

FIGS. 7A, 7B and 7C are flow charts illustrating methods of processing a plurality of images to yield an improved composite image.

FIG. 8 is the digital image of FIG. 3 as shown by a computer display; the digital image further includes a rectangular boundary demarcating a region of the image for quantitative analysis.

FIG. 9 is a schematic illustration of a two-dimensional array corresponding to locations on the region of the image designated for quantitative analysis.

FIGS. 10 and 11 schematically illustrate two images of an object wherein the object of one image is offset with respect to the same object in the other image.

FIG. 12 schematically illustrates the superposition of a plurality of images to form a composite image.

FIG. 13 is a composite image of the planet depicted in FIG. 3 processed according to a preferred embodiment of the invention.

FIG. 14 is a digital image of the moon obtained using a telescope and CMOS camera.

FIG. 15 is composite image formed by selecting and superimposing a plurality of blurred images such as depicted in FIG. 14.

FIG. 16 is a different image of the moon also obtained using a telescope and CMOS camera.

FIG. 17 is a composite image formed by selecting and superimposing a plurality of images such as depicted in FIG. 16.

FIG. 18 is a different image of the moon also obtained using a telescope and CMOS camera.

FIG. 19 is a composite image formed by selecting and superimposing a plurality of images such as depicted in FIG. 18.

FIGS. 20, 21, and 22 are different views of binoculars having a CMOS camera attached thereto for recording images.

FIG. 23 is a digital image of a terrestrial landscape, a building, obtained using a binoculars having a CMOS camera.

FIG. 24 is a composite image formed by selecting and superimposing a plurality of images such as depicted in FIG. 23.

FIGS. 25A and 25B are flow charts illustrating a method of processing a plurality of images to form a composite image using drizzle filtering.

FIG. 26A is a schematic representation of the footprints of seven captured images covering a portion of a virtual image.

FIG. 26B is a schematic representation of a plurality of captured images covering a virtual image.

FIG. 27 is a flow chart illustrating a method of processing a plurality of images to form a composite image using drizzle filtering.

FIG. 28 is a schematic representation of drizzling, showing an association of an input pixel grid of a captured image with an array of smaller regions.

FIG. 29 is a schematic representation of drizzling, showing the mapping of an array of small regions of the captured image to corresponding pixels in the virtual image.

FIG. 30 is another schematic representation of drizzling, showing the mapping of an array of small regions of the captured image to corresponding pixels in the virtual image.

FIG. 31 is another schematic representation illustrating one example of resulting pixel magnitudes on a 3×3 pixel portion of the virtual image.

FIG. 32 is a digital image of one captured image using a telescope system.

FIG. 33 is a digital image of an image created using the drizzle algorithm depicting the same image area as shown in FIG. 32.

### DETAILED DESCRIPTION OF THE CERTAIN EMBODIMENTS

The following detailed description is directed to certain specific embodiments. However, the invention can be embodied in a multitude of different ways. Reference in this specification to “one embodiment” or “an embodiment” means that a particular feature, structure, or characteristic described in connection with the embodiment is included in at least one embodiment. The appearances of the phrase “in one embodiment,” “according to one embodiment,” or “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The various methods, systems, and techniques disclosed herein can be used to form composite images. Embodiments include methods of processing multiple images from a telescope to form a virtual composite image, which represents a desired area of interest, for example, an area of the sky showing particular stars of interest. The virtual image may be larger than any one of the images that are used to form the virtual image. Numerous electronic images, each encompassing a portion of the virtual image, are captured and processed using image processing techniques, including drizzling. Information from the images (e.g., pixel magnitudes) is used to change the pixel values of the virtual image until the virtual composite image is complete. The pixel magnitude of each pixel in the virtual image may be generated from corresponding pixels in multiple captured images that depict a portion of the virtual image. After an image is captured but before it is used to change the pixel values of the virtual image, the captured image can be analyzed and rejected if its quality is poor (for example, due to lack of sharpness, distortion, and/or smearing). Results from the image analysis can also be used to change an imaging control parameter for capturing subsequent images. The telescope can be repositioned, for example, after capturing an image, either based on the analysis of a captured image or other criteria. Embodiments also include a telescope system that may comprise a telescope, a camera that captures images formed by the telescope, and a computer processor configured to receive the captured images, analyze the images, change pixels in the virtual image using a drizzle algorithm, and adjust imaging control parameters to capture subsequent images for use in forming the virtual image.

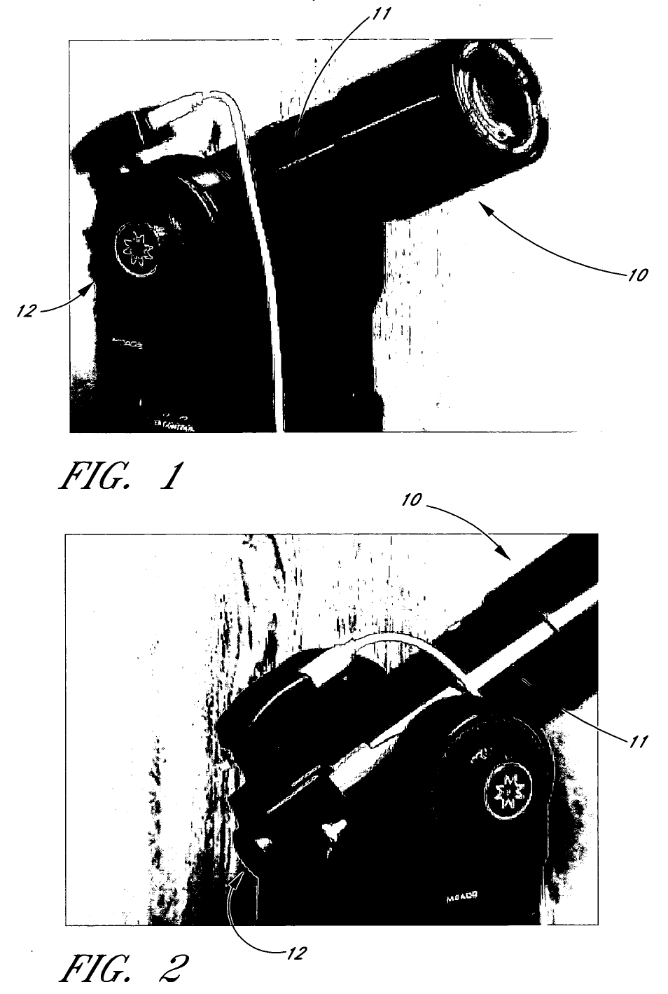

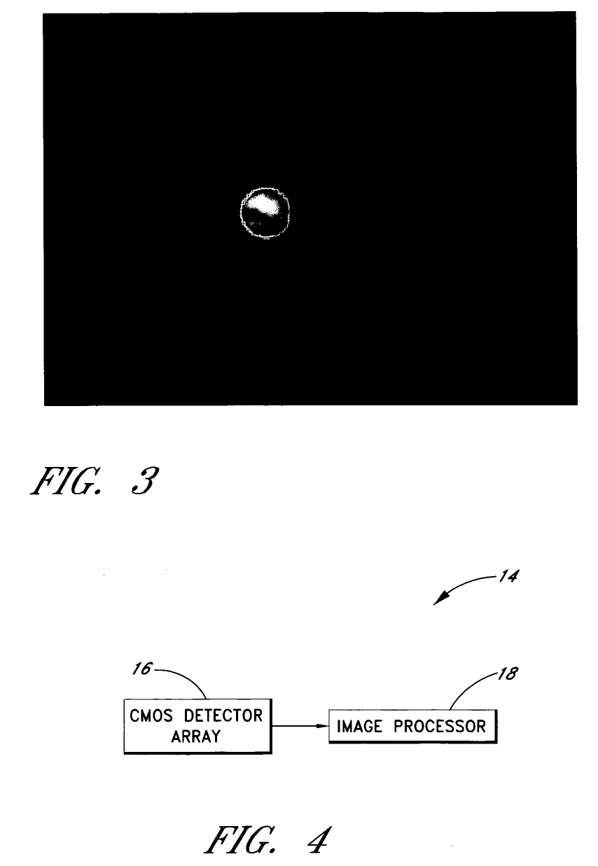

FIGS. 1 and 2 show one embodiment of a telescope 10 comprising telescope optics disposed in a telescope body 11 such as a telescope tube assembly comprising a telescope tube. The telescope optics may comprise a primary and secondary mirror (not shown) as well as possibly other optics such as, for example, a corrector plate in some embodiments. Other optics such as eyepieces may also be included. The telescope 10 should not be limited, however, to any particular design as other configurations may be employed. The telescope 10, for example, may be reflecting, refracting, or catadioptric and may include, for instance, a wide variety of optical and mechanical designs both those well known in the art as well as those yet to be devised.

Embodiments of the telescope 10 can include any type of earth-based telescope, such as a refractor telescope or a reflecting telescope. For example, the telescope 10 can comprise a Newtonian telescope, a Catadioptric telescope, a Maksutov-Cassegrain telescope, a Schmidt-Cassegrain telescope, or a Dobsonian telescope. The size of the telescope 10 can include those telescopes typically used by all levels of users, for example, amateur astronomers, professional astronomers, institutions, and/or land-based observatories, including a 60 mm or smaller telescope, or up to an 8 m or larger telescope, or a set of telescopes used in combination to form a an equivalent larger telescope. In other embodiments, the telescope 10 comprises binoculars. As with the telescope embodiments described above, a plurality of images can be captured and composite image can be formed using the drizzle process and the other processes and devices described herein.

The telescope 10 can include a camera 12 that has a detector for capturing images formed by the telescope 10. In this embodiment, the camera 12 is a CMOS camera. The CMOS camera 12 comprises a CMOS detector array preferably disposed at a focal plane or image plane of the telescope 10. The CMOS detector array comprises a two-dimensional array of optoelectronic devices or more specifically, optical detectors that convert optical power into electronic signals. The optical detectors in the two-dimensional array are referred to as pixels. An optical image formed on the image plane of the telescope 10 will be sensed by the CMOS detector array, the various optical detectors each outputting an electrical signal dependent on the amount of light incident on the respective detector pixel. In this manner, an optical image can be recorded as an electronic image. The electronic image formed from the CMOS detector array includes an array of pixels that correspond to the CMOS detector array pixels. Each pixel of the electronic image can have a pixel magnitude and an associated position. Such electronic images are often referred to as digital images, e.g., in the case where the electronic signals are digitized.

As described above, the optical detectors in CMOS detector arrays are based on CMOS (Complementary Metal Oxide Semiconductor) device technology. Electronics for handling the electrical signals output from the plurality of detectors may be incorporated with the CMOS detector array. Advantageously, CMOS detector arrays are inexpensive and thus preferred. The camera, however, employed in conjunction with the telescope 10 should not be limited to CMOS detectors arrays. Other optoelectronic focal plane arrays such as for example CCD detector arrays may be employed in certain scenarios.

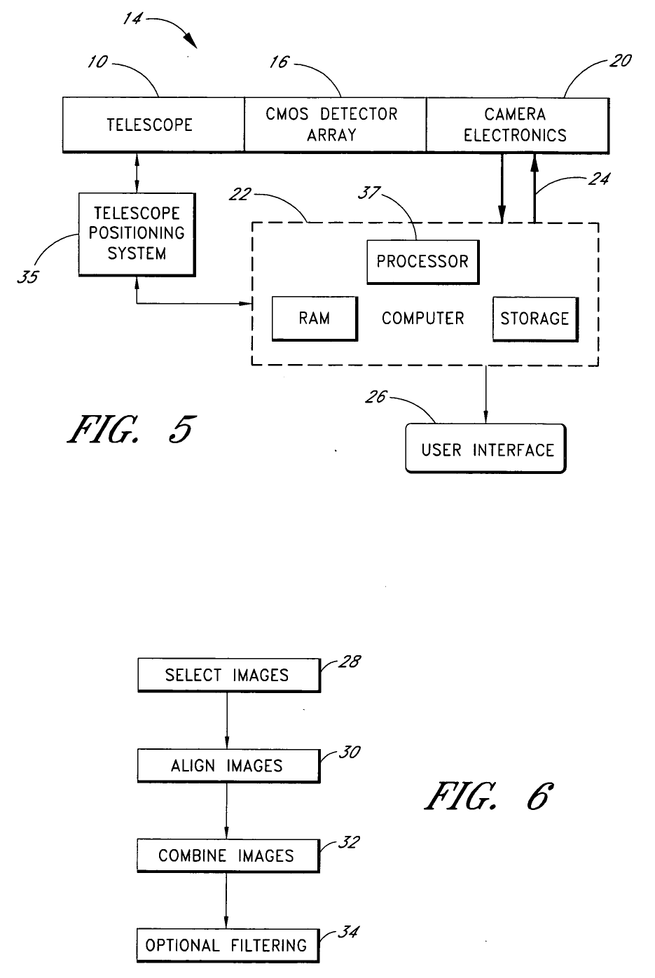

The telescope 10 can be focused on a celestial body such as the moon, planets, stars, comets, brighter deep space objects, or other objects in space or alternatively on a terrestrial object, thereby producing an optical image on the focal or image plane. With the CMOS camera 12, the optical image can be converted into an electronic image. FIG. 3 shows an exemplary electronic image of a planet, Mars, magnified by the telescope 10. The image of Mars is somewhat blurred possibly resulting from atmospheric distortion. As described above, variations in the index of refraction of the atmosphere with time, location, altitude, and temperature, introduce generally unpredictable deviations in the path of light propagating to the telescope. The result is image degradation.

To reduce blurring, optical images are captured by the CMOS focal plane array, and the resultant electronic images are transferred to an image processor. The image processor performs processing that yields an improved image. A block diagram of an imaging system 14 comprising a CMOS detector array 16 and an image processor 18 is depicted in FIG. 4. The image system 14 preferably comprises imaging optics such as a telescope, which is an afocal optical system. Other optical systems, however, may be employed in conjunction with the detector array. For example, the optical system may comprise binoculars as described below. An exemplary image processor 18 may be in the form of analog and/or digital circuits or electronics, one or more microprocessors or computers or any combination thereof. Other structures for implementing processing described herein, both structures well know as well as those yet to be devised, may be employed. For example, multiple image processors may be used.

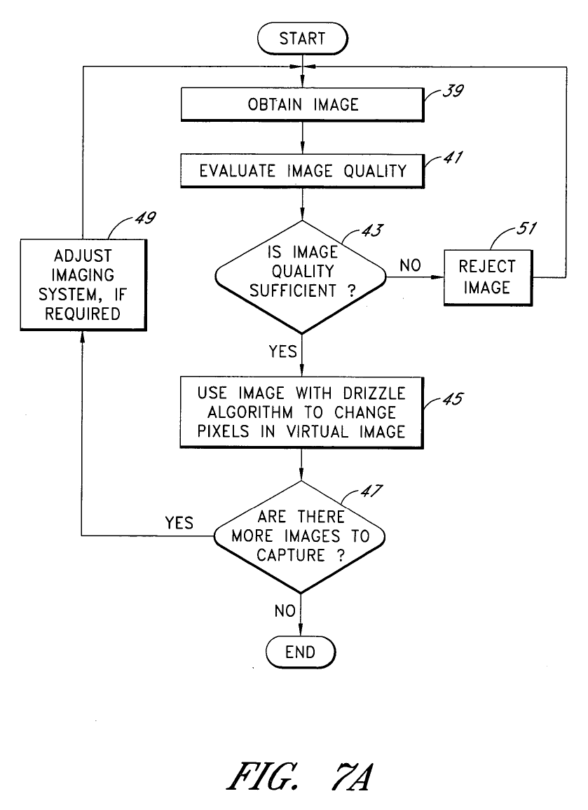

One preferred embodiment of the imaging system 14 is illustrated by the block diagram shown in FIG. 5. The imaging system 14 includes a telescope 10, such as a type described above. A CMOS detector array 16 is coupled to the telescope 10 and disposed to capture images formed by the telescope 10. Camera electronics 20 may be included with the CMOS detector array 16 as shown. The camera electronics 20 may comprise CMOS circuitry on the same chip as the detector array or may comprise electronics on separate chips, boards, modules, or other electronic structures. In certain embodiments, the camera electronics 20 may digitize, amplify, control, store, or otherwise manipulate the signals output by the detector array 16. The camera electronics 20 preferably facilitate transfer of electrical signals output by the plurality of optical detectors to separate components. Other tasks may be implemented elsewhere in certain embodiments.

The imaging system 14 shown in FIG. 5 further comprises a computer 22. In various preferred embodiments, the optical processing is implemented at least in part by the computer 22. Accordingly, the optical processor 18 depicted in FIG. 4 is preferably embodied at least in part by a computer 22 such as schematically illustrated in FIG. 5, as processor 37. Other processing tasks may be carried out elsewhere and the computer may perform additional functions as well. In alternative embodiments, the optical processor 18 may be implemented by devices other than a computer. This computer may comprise a microprocessor, a personal computer or work station or other type of computer as well. FIG. 5 shows electrical connection between the camera electronics 20 and the computer 22 provided by a data link 24. This data link 24 can comprise, for example, a USB connection. Other types of connections and formats can be employed. The data transfer should not be limited to electrical or optical links. These connections may be formed for example by wire or cable but also include wireless data transfer.

The computer 22 shown in FIG. 5 includes Random Access Memory (RAM) as well as storage which may comprise, for example, a magnetic or optical hard drive, magnetic or optical disks or other data storage devices. In various preferred embodiments, the image processing is performed at least in large part using RAM and potentially data storage such as a hard drive. The RAM may be employed to temporarily store and process electronic images. The storage devices may also be used to store images as well as possibly program instructions. Various other implementations and configurations, however, can be utilized. The computer 22 shown further includes a user interface 26, which may, for example, comprise a computer display, a keyboard, and/or a mouse. Other user interfaces 26 both those well know as well as those yet to be devised may also be employed.

The imaging system 14 shown in FIG. 5 further comprises a telescope positioning system 35 coupled to the telescope 10 and the computer 22. The telescope positioning system 35 receives signals from the computer 22 to direct the telescope 10 toward a desired object or area. The computer 22 generates the telescope control signals based on a predetermined criteria, such as criteria from a user's input, software programs running on the computer, or dynamically based on analysis of one or more images captured by the imaging system 14. The user may, for example, direct the telescope 10 toward a particular celestial object of interest. Alternatively, in some embodiments, the user may specify the celestial object by name and the computer 22 will automatically aim the telescope 10 toward that object.

During operation, the user may also define a desired area of interest for generating a composite image. The defined area of interest corresponds to and is referred to herein as a “virtual image,” a defined image space that comprises pixels. The user may in some cases designate a desired area and corresponding “virtual image” that is larger than any of the images used to form the composite image. In some embodiments, the virtual image is at least about 100 to 1000 percent as large at a captured image although the size may be larger or smaller.

To facilitate generating a composite image and to reduce image degradation (e.g., blurring), a plurality of images are obtained, or captured, over the area of interest and are combined to form the composite image. After one or more images of sufficient quality are captured of a particular portion of the area of interest, the telescope positioning system 35 can reposition the telescope to capture an image that includes a portion of the area of interest not captured in the previous image, and/or not captured in any of the previously captured images. The telescope 10 can also be repositioned so that the captured image overlaps a portion of the virtual image that was included in a previously captured image. Although the telescope positioning system 35 may be used to alter the telescope 10 prior to capturing the different images as well as to maintain the telescope directed on a particular celestial object, in some embodiments, drift in the field-of-view of the telescope 10 may produce images translated with respect to each other that may be combined to form the composite image.

In some applications, the telescope 10 moves sufficiently such that the captured image is translated an amount comprising more than the pitch of the pixels for the captured images or more than twice the pitch. In some embodiments, the translated amount can be between one-tenth ( 1/10) of a pixel to three-quarters of the field-of-view of the camera 12. In some embodiments, the translated amount can be between one-tenth ( 1/10) of a pixel and three-quarters (¾) of the size of the virtual image. The telescope 10 can be moved so that images covering the entire area of interest are captured. In some embodiments a first image is obtained and the telescope is moved and an image is captured a plurality of times between the first and last images. In some embodiments, the telescope 10 is moved and images are captured between 1 and 100 times after capturing a designated first image and prior to capturing a designated second image. Values outside these ranges are possible.

As described above, in some cases, the field-of-view of the telescope drifts and this drift contributes to the respective shift between images captured at different times. This drift may occur even if the positioning system 35 is set to maintain the telescope 10 directed at substantially same direction. Accordingly, a multitude of images may be obtained as the telescope drift. These images or a portion thereof may be combined to form the composite image, which may be larger than the individual captured images.

Each captured image comprises pixels. These pixels depict a portion of the area of interest and correspond to a portion of the virtual image. As discussed above, the virtual image also comprises pixels. The resulting composite image is formed by changing the pixels of the virtual image using information from the captured images. In various preferred embodiments, these images are acquired by the detector array 16 onto which optical images are focused by the telescope 10. The detector array 16 captures these images at various points in time and produces electronic representations of the images. The images can be somewhat faint and/or blurred, and can require image processing so that they are suitable for use in the composite image.

The images may be captured automatically with the assistance of computer or microprocessor control or control electronics and/or control signals. Alternatively, the images may be taken manually in some embodiments. Multiple exposures can be captured using shutter control wherein a shutter is opened to expose the detectors to the optical image. Automatic or manual control of exposure time may be provided. The exposure may range, for example, between about 1/5000 second to 30 seconds. Values outside this range may also be used. The images can be displayed in real time and analyzed. A quantitative measure of the quality of the image as well as other measurable characteristics can be provided to the user via the user interface, e.g., display. The quality of the images can be evaluated to determine if characteristics of the images meet certain criteria (e.g., sharpness, smearing, and distortion) so that the images can be used to create the composite image or for other purposes. Images whose characteristics do not meet the criteria can be rejected. Analysis of the images can also be used to determine imaging control parameters, for example, gain, DC offset, exposure time, focus and/or position of the telescope. Signals based on these control parameters can be sent to the telescope positioning system 36 and to the camera electronics to change the imaging control parameters for subsequent images obtained using the imaging system 14. Adjustment to the telescope or telescope system can be made in real time as the images are being obtained. Similarly, data can be presented to the user in real time as the images are being captured. The user can, in response to such data, decide to adjust parameters of the telescope or telescope system.

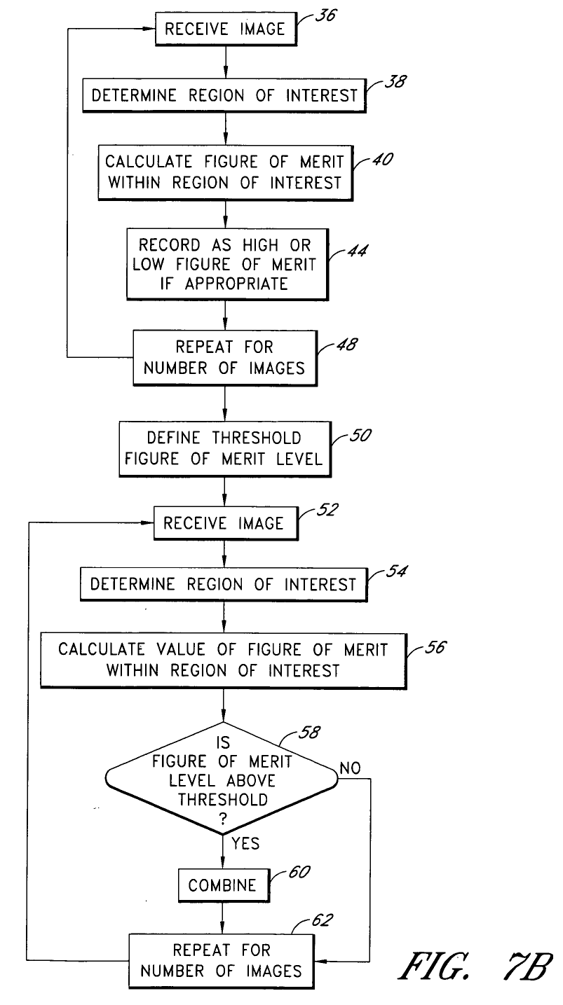

The multiple electronic images can be processed to reduce image degradations, such as blurring. FIG. 6 shows a flow chart that illustrates one preferred embodiment of a process for reducing this image degradation. Combining a plurality of images may improve quality such as contrast, and create a composite image that is clearer and less blurred. In various preferred embodiments, the plurality of images used to create the composite image are selected from a larger set of images, the subset selected being of superior quality.

Selection of the images may be based, for example, on the amount of information contained in the image or the region of the image tested. The information content can be measured, for example, by determining the compressibility of the image or the portion of the image evaluated. The larger the information content, the less compressible the images. Conversely, less information content translates into increased compressibility. Images with larger amounts of information can be chosen. Other images below a threshold level of information content may be excluded from the subset of images combined to produce the higher quality composite image.

Selection may alternatively be based, for example, on the level of image degradation such as blurring or conversely on the level of clarity and contrast. Images with higher contrast, those with more variation in signal magnitude from pixel to pixel, can be chosen. Other images below a threshold contrast level may be excluded from the subset of images combined to produce the higher quality composite image.

Combining the images to form a composite image can comprise “summing” pixel magnitudes on a pixel-by-pixel basis using various summing techniques. The aggregate magnitude may be scaled in some cases. In various embodiments, for example, the value of a given pixel in the composite image is the average of the magnitudes of the corresponding pixel in each of the images contained in the subset that is used to form the composite.

Also, the images can also be combined to form a composite image using a drizzle algorithm, described hereinbelow. It will be appreciated that there may be various ways of implementing this algorithm, only one of which is described herein for purposes of illustration of the algorithm. The drizzle algorithm is described in available references, including, for example, “Drizzle: A Method for the Linear Reconstruction of Undersampled Images,” Publication of the Astronomical Society of the Pacific 114: 114-152, February, 2002. Composite images can be formed using the drizzle algorithm, or using the drizzle algorithm in combination with one or more other methods of image reconstruction or image processing.

Prior to combining the images, the images may be translated such that the common features in the image are substantially aligned. Translating the images preferably substantially removes the effects of movement of the features in the image over the period of time during which the plurality of images are obtained. Such movement may result, for example, from atmospheric disturbances, vibrations of the telescope, or the rotation of the earth. Additional filtering may be employed to improve the quality of the image. This filtering may comprise contrast-enhancing filtering for increasing the contrast. In some embodiments, this filtering may be performed after the images have been combined to form the composite. This filtering is, however, optional.

FIG. 6 outlines several of these processing steps described above. Block 28 corresponds to selecting a subset of the images from a larger set of images. This selection process preferably improves the quality of the composite image by rejecting images with increased degradation. Block 30 corresponds to aligning the images. In various preferred embodiments, the images are preferably laterally displaced such that features therein are in substantial alignment. Alignment may be excluded in certain embodiments. Block 32 corresponds to combining the images, for example, by adding the values of the corresponding pixels in each of the selected images together, or by using a drizzling algorithm. As indicated above, the sum of the resulting pixels may be scaled or the aggregate value may otherwise be adjusted. Block 34 corresponds to additional filtering to improve the image quality. Such filtering may comprise, for example, Kernel filtering.

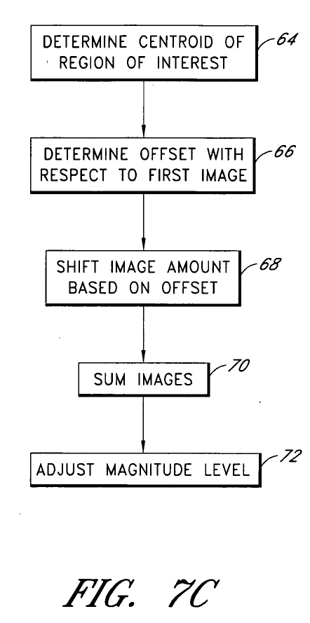

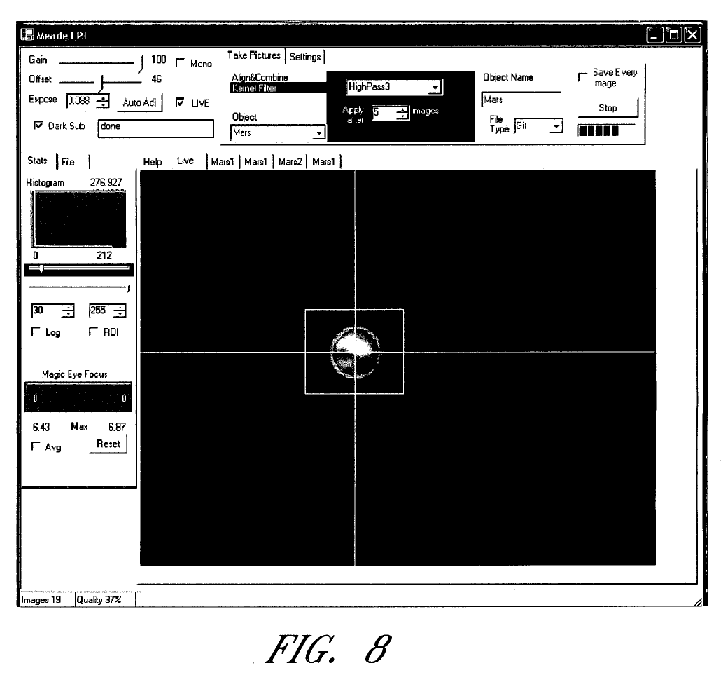

FIGS. 7A, 7B and 7C are flow charts illustrating various processes for improving image quality of a captured image. FIG. 7A shows a high level process for generating a composite image using the drizzle algorithm. An electronic image is obtained from an electronic detector using a telescope 10, as described above, as represented by block 39. The quality of the image is evaluated, as represented by block 41, using one or more of the various techniques disclosed herein. For example, a measure of the sharpness, distortion, or smearing of the image is determined and evaluated against image quality criteria. As represented by block 43, if the image quality is insufficient, the image is rejected, exemplified by block 51, and another image is obtained. If the quality is sufficient, the process continues to block 45 where the image is used with the drizzle algorithm to change one or more pixels of the virtual image that correspond to pixels in the captured image. At block 47, if there are more images to capture because enough images have not been obtained to complete the composite image, the process continues to block 49 where the process optionally determines one or more imaging control parameters and adjusts the telescope and/or the camera electronics appropriately to implement the control parameters. The process then continues to block 39 where another image is obtained. If enough images have been captured to complete the virtual image, the process ends.

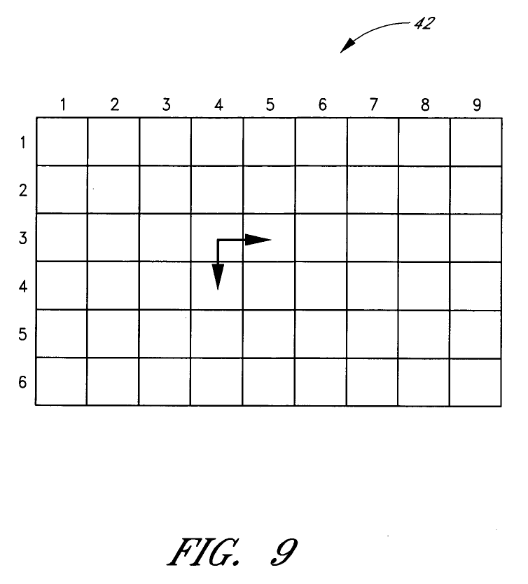

In some embodiments of forming a composite image, an image is received by the optical processor 18 as exemplified by block 36 in FIG. 7B. A portion of the image is selected for sampling the image quality. Performing quantitative analysis over a smaller portion of the image can increase processing speed and may therefore be advantageous. FIG. 8 shows the region of the image selected for quantitative evaluation. FIG. 8 is a reproduction of the image of FIG. 3, which corresponds to a planet, Mars, in the foreground against the dark background of space. The planet, however, can be surrounded by a rectangular boundary that defines the portion of the image selected for analysis. In various preferred embodiments, this region is at least initially selected by the user who may specify the particular region of interest (ROI). Alternatively, the user may select a prominent high contrast feature, such as a bright feature against a dark background or vice versa. Preferably, such a feature has a large amount of detail and information content. The processor 18 may also be configured to select the region of interest, for example, by identifying such a prominent high contrast feature. The size of the region of interest may vary. This step of determining the region for quantitative evaluation is represented by block 38 in FIG. 7B.

FIG. 8 depicts the image of the planet as possibly presented to a user via a user interface. This user interface may comprise, for example, a computer screen in the form of a display such as an LCD display or a computer monitor. As described above, the user interface may further comprise a computer keyboard and/or mouse or other computer controls. With the aid of such an interface, the user can specify a particular region for analysis if the processor 18 is not configured to automatically select such a region.

As shown, the screen can also include additional items such as controls for specifying parameters and options associated with the image processing as well as measured values, for example, of information content, blur, contrast, or focus. The screen may also include a histogram showing the distribution pixel intensity in a plot of intensity (x-axis) versus number of pixels (y-axis).

As illustrated by block 40 in FIG. 7B, a figure of merit is calculated for the region selected for quantitative evaluation. FIG. 9 depicts an exemplary array of pixels 42 corresponding to the pixels in the region designated for quantitative analysis. This exemplary array 42 includes six (6) rows and nine (9) columns totaling 54 pixels. The array 42 in FIG. 9, is only used as an example and the number or rows, columns, and total number of pixels may be larger or smaller depending on the region selected. More generally, the region comprises M rows and N column, totaling M×N pixels.

The figure of merit may be based on or related to the quantity of information in the region of interest. Information, information theory, and detail regarding the measurement of information in a message is provided in the seminal paper by C. E. Shannon, “A Mathematical Theory of Communication” The Bell System Technical Journal, Vol. 27, pp. 379-423, 623-656, July, October, 1948, which is incorporated herein by reference in its entirety. The amount of information is one method for assessing the images quality. Images of the same object containing different amounts of information may indicate variation in the quality of the images. For example, an image with degradation such as blurring, low resolution, loss of detail, and/or other affects will generally contain a relatively low amount of information. Such degradation may result, for example, from optical distortion, vibration and movement of the telescope or optical system, electronic noise in the detection apparatus, or from other sources. Conversely, images with large information content may reflect significant resolvable detail. Information content, for example, is also related to the ability to predict from the value of signal in one pixel, the signal in an adjacent pixel. Accordingly, in various preferred embodiments the information content is measured to evaluate the quality of the images such as the resolvable useful detail in the images.

In various embodiments, the information content, how much information in, e.g., the region of interest, is assessed by calculating the compressibility within the designated region 42. The compressibility is indicative of the amount of information contained in the image or designated region 42. For example, a completely dark image such as of the dark sky would have little information and be highly compressible. Conversely, a quality image with extensive detail such as of the surface of the moon would contain large amounts of information and be less compressible. Accordingly, an image file, such as a .TIFF, .JPG, containing an image of the dark sky, if compressed, would be smaller compared to a similar compressed file of the detailed image of the moon. Similarly, optical images of the same object should include the same amount of information, and therefore compress to the same size, unless one of the images is substantially degraded. The degraded image would contain less information than the un-degraded image and could be compressed more. Accordingly, compressibility can be used as a measure of information content, and as described above, the amount of information in like images can be used to assess the quality of the image.

One process for determining the information content comprises adaptive delta modulation. Other approaches, both those well known as well as those yet to be devised may also be employed. Other values besides the compressibility can be used to characterize the information content, and hence the quality of the image in the designated region.

Useful background may be found, e.g., in the Space Telescope Science Institute STSDAS User's Guide, Science Computing and Research Support Division, STSCI, Baltimore 1994, and Barnes, Jeanette, A Beginner's Guide to Using IRAF. IRAF Version 2.10, NOAO, Tucson 1993, which are also each incorporated herein by reference in there entirety. See also, Dantowitz, R.; “Sharper Images Through Video”, Sky and Telescope, Vol. 96., No. 2, p. 48, August 1998, Hale, A. S, Danotwitz, R., Kozubel, M., Teare, S., Gillam, S. G; “The Selective Image Reconstruction(SIR) Imaging Technique: Application to Planetary Science” AAS DPS Meeting #33, Bull of AAS, Vol. 33 p. 1143, and Thompson, L. A. “Adaptive Optics In Astronomy”, Physics Today, Vol. 47, No. 12, pp. 24-31, 1994, which are also each incorporated herein by reference in their entirety.

In various alternative embodiments, the figure of merit used to assess the quality of the images is based on the level of contrast. The level of contrast may be assessed by calculating the variance or standard deviation of signal values among the pixels within the designated region 42. The variance can be computed according to the following equation:
σ²=<I(i,j)²>−<I(i,j)>²
where I(i,j) is the signal level at pixel (i,j), i corresponds to the row and j corresponds to the column for each of the M×N pixels in the array 42. The standard deviation, e.g., the square root of this value, may also be employed. Other values besides the variance and standard deviation can be used to characterize the variation, and hence the contrast level in the designated region.

In another approach for quantifying the level of contrast, the difference in signal intensity between adjacent pixels is determined across the array 42. For example, in one embodiment, the variation can be evaluated by assessing the difference in signal level between a given pixel and the pixel to the right as well as the pixel beneath. For example, for the pixel (3,4) shown in FIG. 9, pixels (3,5) and (4,4) are considered. The signal for these two adjacent pixels is compared to the signal for the pixel (3,4). More generally, for a pixel (i, j), comparison is made with the pixels (i+1,j) and (i,j+1). The value calculated can be based on signal difference between adjacent pixels. Each pixel in the array is preferably considered. A figure of merit based on the sum of these two differences can be used. For example, the first difference δ₁ may be defined as δ₁=|I(i,j)−I(i+1,j)| and the second difference δ₂ may be defined as δ₂=|I(i,j)−I(i,j+1)|. The figure of merit can then be defined as

$${\sum }_{i = 0}^{M} {\sum }_{j = 0}^{N} {Δ}_{i , j}$$

where Δ_{i,j}=δ₁+δ₂. Such a summation is can be computed over the entire array 42 or M×N pixels and yields a figure indicative of the variation among the pixels. A larger value means larger variation and likely higher contrast. Conversely, a smaller value corresponds to smaller variation and lower contrast. This figure of merit can be normalized or scaled. A wide variety of other figures of merit for characterizing the variation and the contrast level can be employed in different embodiments. Moreover, a wide variety of measures of the quality of an image may be utilized.

As indicated by block 44 in FIG. 7B, the figure of merit indicative of the image quality is recorded. Block 44 indicates that the high and the low figure of merit values are recorded. The figure of merit value obtained for the first image analyzed will be both the high and the low threshold level until other images are evaluated to establish a range of levels of the figure of merit.

Another image is received and this portion of the processing represented by blocks 36, 38, 40, and 44 is repeated as exemplified by block 48. Namely, a new image is obtained, the portion of the image to be quantitatively evaluated is determined, and the figure of merit within that region is measured. For this image, the region for quantitative analysis may remain the same as originally designated by the user or determined by the processor 18. In other embodiments, the location (and potentially the size) of the region may be reevaluated and redefined. The value of the figure of merit for this image is compared with the previously recorded high and low figure of merit values. If this figure of merit value is either higher than the recorded high figure of merit value or lower than the low figure of merit value, this figure of merit value is recorded as the high or low figure of merit value, respectively.

This portion of the processing, represented by blocks 36, 38, 40, and 44 is repeated a number of times. This number may be set by the user via the user interface. In other embodiments, this number may be established by the processor 18. This number may range, for example, between about 5 and 10, or up to 100 or more, however, the number of times that this portion of the processing is repeated may be outside these ranges.

As shown by block 50 in FIG. 7B, a threshold figure of merit value is defined. Preferably, this threshold figure of merit value is based at least in part on the figure of merit values recorded (see block 44 ) for the plurality of images previously analyzed. In some embodiments, this threshold figure of merit value is based on the information content measured within the region of interest for these images. In some embodiments, this threshold figure of merit value is based on the contrast measured within the region of interest for these images. Still other embodiments are possible.

In various preferred embodiments, upper and lower values such as the maximum and minimum value of the recorded information content or compressibility are identified. The threshold levels may be determined using these values of high and low information content or compressibility. For example, the threshold value may be a value between maximum and minimum recorded information content and/or compressibility, such as half-way between these values or about 50% of the difference between the maximum and minimum. The threshold need not be limited to the midway point. Other levels closer to maximum or closer to minimum may be used instead. In some embodiments the user can specify whether the threshold is about 10% above the minimum, about 20% or 30%, etc., or whatever value he or she desires. Other approaches can be employed to provide a threshold value.

In other preferred embodiments, upper and lower values such as the maximum and minimum value of the recorded variations are identified. In the case where the standard deviation is employed as a measure of contrast, these values may correspond to σₘₐₓ and σₘᵢₙ, respectively. The threshold levels may be determined using these values of high and low variation. As discussed above, for example, the threshold value may be a value between σₘₐₓ and σₘᵢₙ, such as half-way between these values or about 50% of the difference between the maximum and minimum. Other levels closer to maximum or closer to minimum may be used instead. In some embodiments the user can specify whether the threshold is about 10% above the minimum, about 20% or 30%, etc., or whatever value he or she desires. Other approaches can be employed to provide a threshold value.

The threshold determines the quality level of additional images that are used to form the composite image. Accordingly, blocks 52, 54, 56, 58, 60, and 62, represent another portion of the process wherein additional images are received and evaluated. In particular, for each image, the region for quantitative analysis is determined and the figure of merit evaluated within this region is computed. As discussed above, the region for analysis may be the region originally designated by the user or the image processor 18. Alternatively, a new region may possibly be employed. The figure of merit may be assessed by measuring the information content and/or compressibility, contrast and/or variation, as well as other quality indicators within the region of interest, as discussed above.

The figure of merit value of the region is compared with the threshold level as indicated by block 58. If the figure of merit value is larger than the threshold level, the image is added to the composite. If the figure of merit value is less than the threshold level, the image is not added to the composite. Accordingly, if the threshold is high, higher quality images will be added to form the composite. Similarly, if the threshold is low, lesser quality images will be included in forming the composite.

This portion of the process is repeated a number of times as indicated by block 62. The number of times that this process is repeated may depend on the number of images captured, may be specified by the user, or may be determined by the processor 18, or otherwise realized. This number may be, for example, between about 15 to 100, e.g., between about 15 and 30 or between about 50 and 100, or more, however, the number of times that this portion of the process is repeated may be outside these ranges as well. The number of images selected and added to form the composite may, for example, be between about 50 to 100 although a more or less number can be used. In some embodiments, between about 200 to 300 images can be evaluated, although the number may be larger or smaller. To Capturing 200 to 300 images may take 2 to 3 minutes with 1/10 second exposure time.

As indicated above, a wide range of algorithms can be employed as a measure of quality and the specific measurement and/or calculation to assess such image quality need not be limited to those specifically recited herein. Moreover, although in discussing the process shown in FIG. 7B, the information content and contrast level are determined to select the images to be used to form the composite, in other embodiments, different characteristics may be measured or calculated to make such a selection. Preferably, such characteristics are indicative of the quality of the image, such that only higher quality images are added to the composite, although the process should not be so limited.

Note that the quality evaluation, e.g., information content, contrast, etc., can be employed to offer additional functions to the user. The calculated value of figure of merit such as information content or contrast, for example, can be displayed for images obtained to provide the user with a quantitative measure of the image quality. Such a value can be presented graphically to the user. This feedback may assist the user, for example, in focusing the telescope. The processor can be set to monitor quality as the telescope is adjusted through the focus. Preferably, the display provides the quality level of the current image as well as the highest quantity obtained so that the user could determine the best focus as determined by the value calculated for figure of merit or image quality.

As discussed above in connection with FIG. 6, the process for improving image quality preferably further comprises aligning features in the images. FIG. 7C shows a flow chart that outlines how alignment can be achieved. In various embodiments, therefore, the summation represented by block 60 in FIG. 7B includes an alignment procedure such as presented in the flow chart of FIG. 7C.

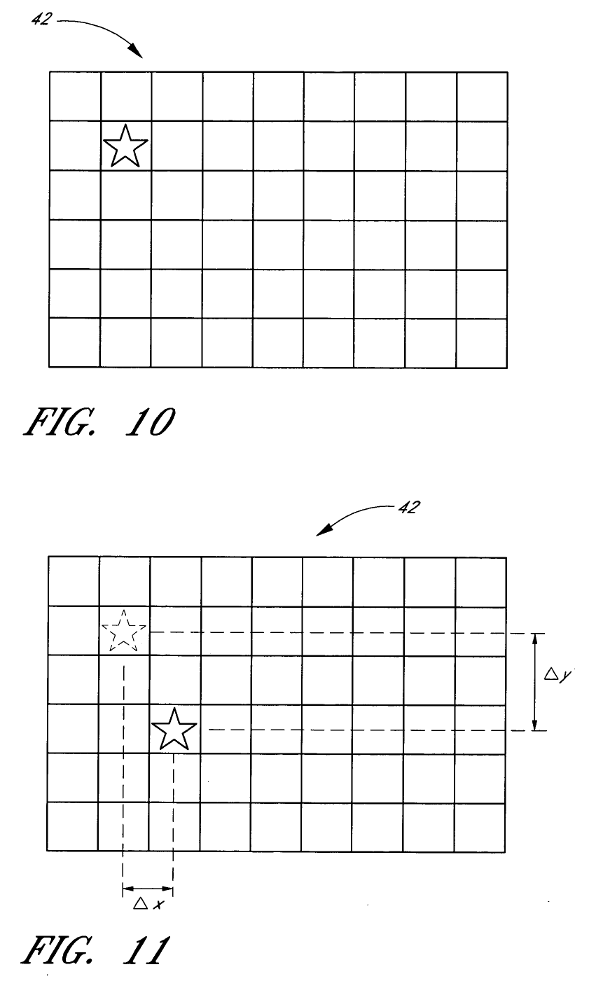

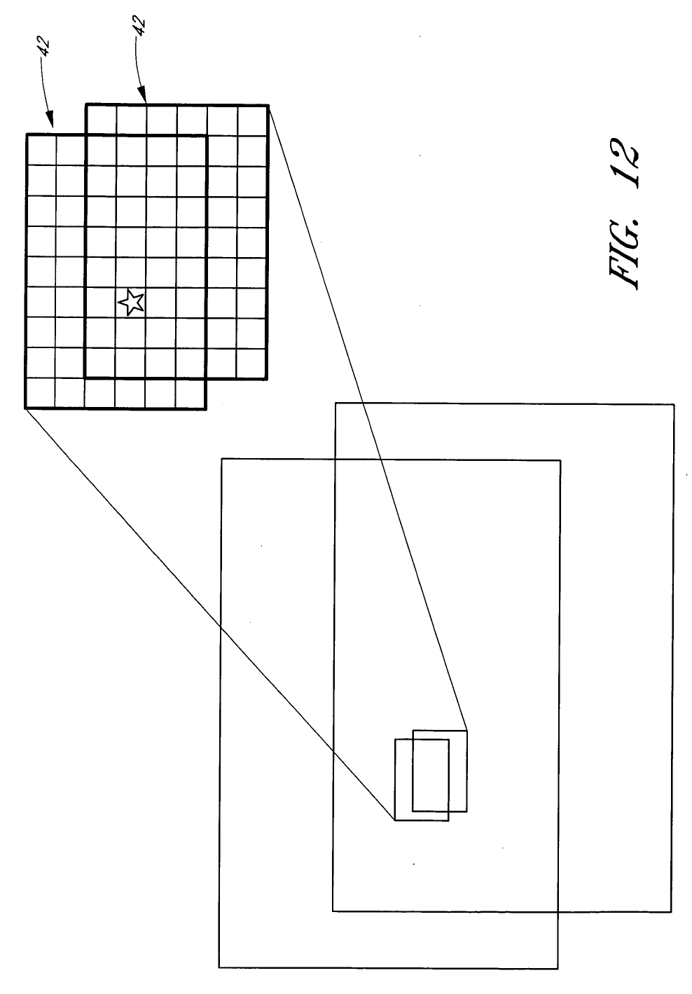

For reasons explained above, the features in one image may be offset with respect to another as schematically illustrated in FIGS. 10 and 11 where the star appears to have moved. To reduce the image degradation introduced by such an offset, the images are preferably translated. To provide the appropriate amount of translation, the offset is preferably determined, for example, by monitoring the movement of one of the features in the designated region. Preferably, a prominent feature that is highly contrasted against the surrounding background is within the designated region. In various embodiments, the region is preferably so designated because of the existence of such a prominent feature.

In the case where the designated region contains such a high contrast feature, the feature may be located by calculating the centroid of the intensity distribution within the designated region. The centroid preferably corresponds to the point in the region in which the intensity within that region may be considered to be concentrated. Accordingly, in the case where the region comprises an image of a bright star, planet, or other celestial object in a dark background, the centroid can be useful in locating a central position of this bright feature in the image. This position can be monitored to track the shift of the feature(s) in image.

Exemplary expressions that may be employed in calculating the X, Y position of the centroid are presented below

$${X}_{centroid} = \frac{{\sum }_{i = 0}^{M} {\sum }_{j = 0}^{N} i \times ( I ( i , j ) )}{{\sum }_{i = 0}^{M} {\sum }_{j = 0}^{N} I ( i , j )} {Y}_{centroid} = \frac{{\sum }_{i = 0}^{M} {\sum }_{j = 0}^{N} j \times ( I ( i , j ) )}{{\sum }_{i = 0}^{M} {\sum }_{j = 0}^{N} I ( i , j )}$$

where I(i,j) is the pixel intensity value at x=i and y=j. Other representations and methods for calculating the centroid are possible.

In various preferred embodiments, the centroid of the designated region is determined as represented by block 64 in FIG. 7C. The movement of the centroid from one image to the next may be calculated for example, from the offset of the centroid with respect to the centroid obtained for the first image. Block 66 is directed to such an approach. The displacement of the centroid from image to image can also be derived by comparing the location of the centroid to other reference points. Other methods of determining the movement of the centroid or other features are also possible

Preferably, the images are shifted an amount, e.g., Δx, Δy, as shown in FIGS. 10 and 11 corresponding to the displacement of the feature being monitored. As described above, in various preferred embodiments, the central location of this feature may be determined in some circumstances by calculating the location of the centroids of the region of interest. In such embodiment, therefore, the images are preferably shifted by an amount corresponding to the offset between the centroids such that the centroids and the prominent feature within the image are aligned. Block 68 indicates that the image is preferably shifted an amount based on this offset.

FIG. 12 shows two images shifted by an amount corresponding to the offset measured in the designated regions. Preferably, the result is that the features are substantially aligned. FIG. 12 also shows that the images will partially overlap.

As discussed more fully below, one of the two images may be rotated with respect to the other image to provide proper alignment. Two reference points may be monitored to determine rotation. For example, the centroids of two reference points such as two stars may be used to compute the amount of rotation, the center of rotation, and the direction of rotation. Other methods may also be employed.

As discussed above, and represented by block 70 in FIG. 7C, the images are summed. Summation may comprise for example adding the magnitude of the values of the overlapping pixels. Other algorithms may also be employed to merge or superimposed the images onto each other. Preferably, proper alignment is provided such that the superimposed images together enhance the contrast of the image rather than introducing additional blur. Moreover, preferably high quality images (e.g., images with high information content, high contrast images, etc.,) are selected and combined to yield an improved image while poorer quality images are excluded from the composite images.

The magnitude levels may be further adjusted, for example, by scaling or normalizing. Other adjustments are also possible. Such adjustments may be represented by block 72.

The composite image may be further processed by filtering. For example, a contrast-enhancing filter may be employed to further improve contrast. As the composite image possesses little noise, contrast-enhancing filtering will increase contrast and highlight features of the object without adding substantial noise. For example, kernel filtering can be employed. As is well known, with Kernel filtering, a convolution kernel is applied to the pixels in the image to obtain new pixel values. See, e.g., Craig A. Lindley, “Practical Image Processing in C”, Wiley Professional Computing, John Wiley & Sons, Inc. 1991, pp. 368-369. Examples of convolution kernels for several high-pass spatial filters are presented below:

$$\begin{matrix}- 1 & - 1 & - 1 \\ - 1 & 9 & - 1 \\ - 1 & - 1 & - 1\end{matrix} \begin{matrix}0 & - 1 & 0 \\ - 1 & 5 & - 1 \\ 0 & - 1 & 0\end{matrix} \begin{matrix}1 & - 2 & 1 \\ - 2 & 5 & - 2 \\ 1 & - 2 & 1\end{matrix}$$

Other types of kernel filters can also be employed. Other filters and filtering techniques other than Kernel filtering may also be used for improving image quality or altering the image as desired.

For example, another technique that can be employed to improve image quality is dark subtraction wherein the fixed pattern noise of the detector is subtracted out of the image. A table or database of fixed pattern detector noise can be created that comprises the fixed pattern noise for a variety of exposure levels for the detector. This database may be generated by capturing a number of images over different time intervals with a closed shutter over the detector array. For a given exposure setting, therefore, the appropriate fixed pattern noise can be obtained from the database by the processor and subtracted out of the electronic image. Fine adjustment can also be performed by scaling the fixed pattern noise that is subtracted out of the image. Such fine tuning may be useful where the database does not include fixed pattern noise exactly matching that produced for the exposure time selected. For example, if the database includes fixed pattern noise for 1/600 second and 1/500 second exposure times and the CMOS camera is set for 1/650 second exposure, the fixed pattern noise for 1/500 can be selected and the fixed pattern noise scaled appropriately. Scaling can be employed in other circumstance also to adjust the image.

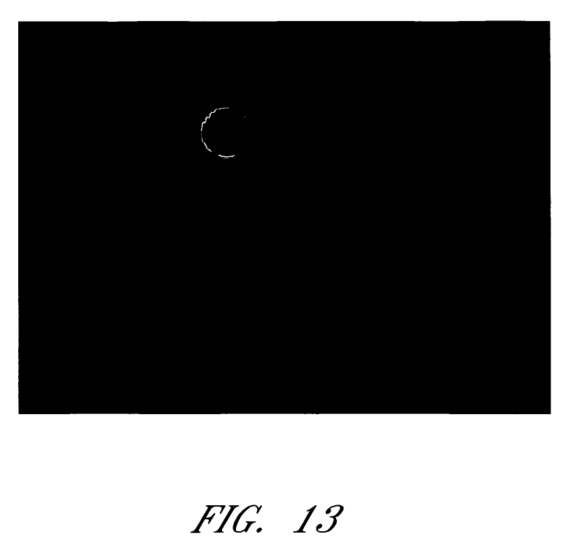

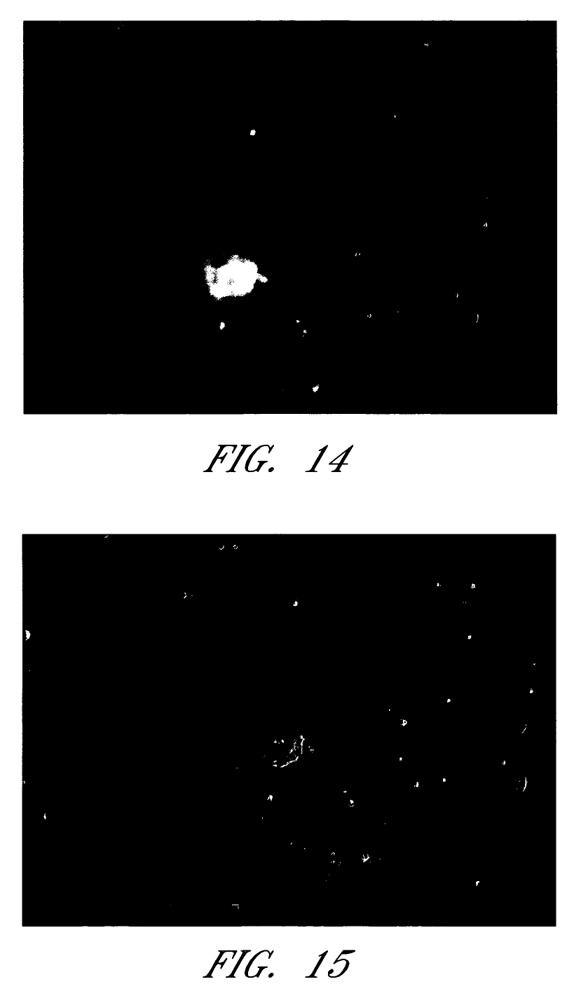

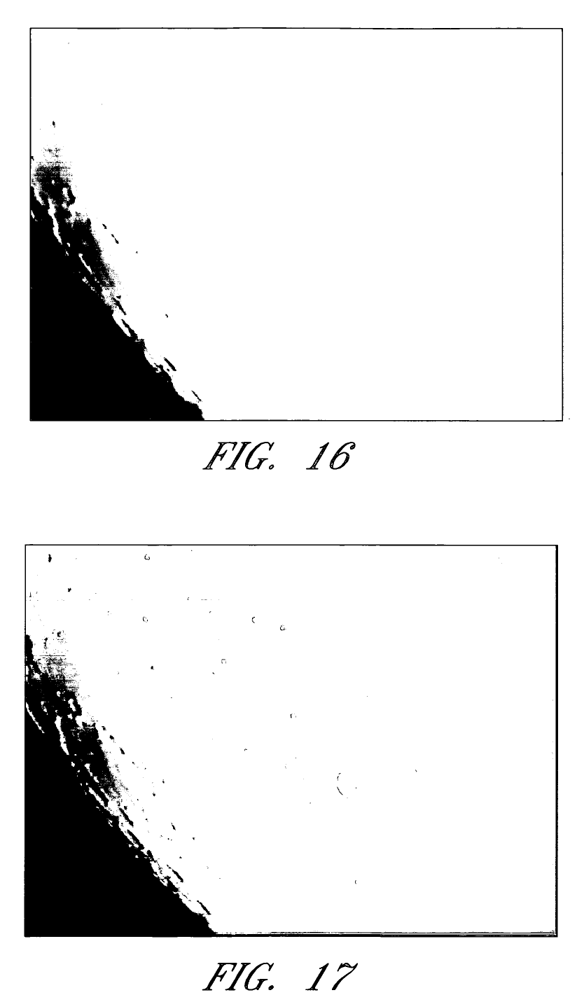

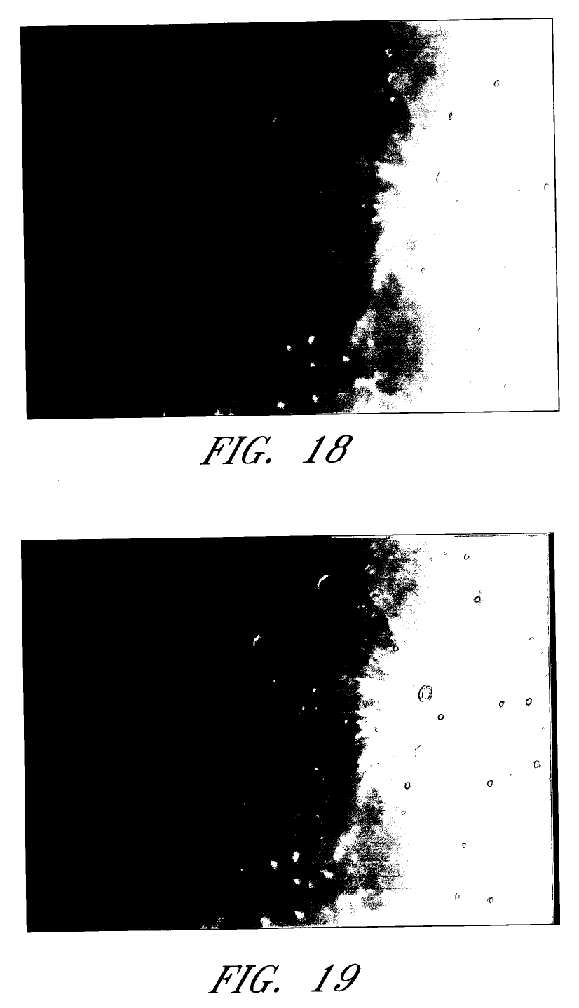

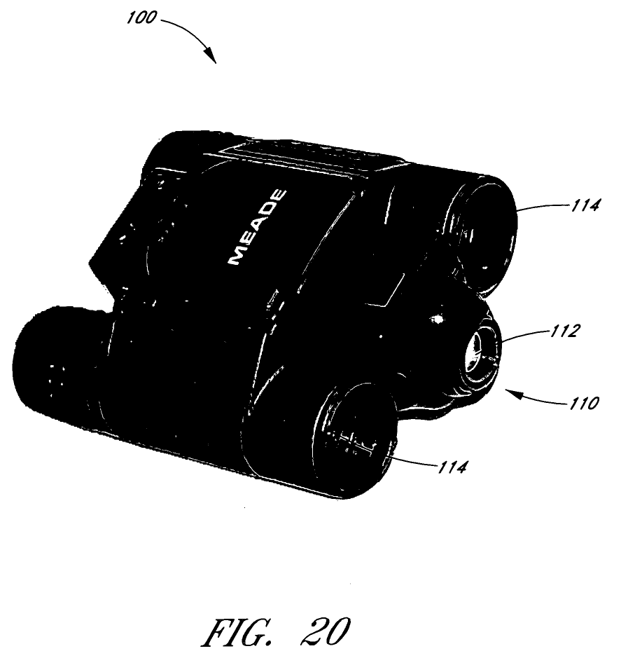

FIG. 13 is a composite image based on images of Mars similar to that shown in FIG. 3. Examples of the successful performance of the image processing described herein are also shown in FIGS. 14-19. (The images in FIGS. 14-19, however, were not processed using a drizzle algorithm which is discussed more fully below.) FIGS. 14, 16, and 18 correspond to images of the moon having blur. FIGS. 15, 17, and 19 correspond to respective composite images formed using imaging processors and image processing techniques described herein. The composite image in FIG. 15 was formed using a plurality of blurred images similar to that shown in FIG. 14. The composite image in FIG. 17 was formed using a plurality of blurred images similar to that shown in FIG. 16, and the composite image in FIG. 19 was formed using a plurality of blurred images similar to that shown in FIG. 18. The enhanced contrast is readily discernible.

Such improved image quality can be achieved by employing the embodiments discussed above, for example, in connection with FIGS. 6, 7A, 7B, and 7C as well as FIGS. 8-12. Alternative approaches are also possible. The processing steps may be interchanged and may be executed in different order or may be excluded or replaced altogether. Additional processing steps and features can also be added.

Additionally, logic may be executed on the architecture such as shown for example in FIG. 5 in accordance with processes and methods described and shown herein. These methods and processes include, but are not limited to, those depicted in at least some of the blocks in the flow chart of FIG. 6 as well as the schematic representations in FIGS. 9-12 and flow charts in FIGS. 7A-7C. These and other representations of the methods and processes described herein illustrate the structure of the logic of various embodiments of the present invention which may be embodied in computer program software. Moreover, those skilled in the art will appreciate that the flow charts and description included herein illustrate the structures of logic elements, such as computer program code elements or electronic logic circuits. Manifestly, various embodiments include a machine component that renders the logic elements in a form that instructs a digital processing apparatus (e.g., a computer, controller, processor, laptop, palm top, personal digital assistant, cell phone, kiosk, videogame, or the like, etc.) to perform a sequence of function steps corresponding to those shown. The logic may be embodied by a computer program that is executed by the processor as a series of computer- or control element-executable instructions. These instructions or data usable to generate these instructions may reside, for example, in RAM or on a hard drive or optical drive, or on a disc or the instructions may be stored on magnetic tape, electronic read-only memory, or other appropriate data storage device or computer accessible medium that may or may not be dynamically changed or updated. Accordingly, these methods and processes including, but not limited to, those depicted in at least some of the blocks in the flow chart of FIG. 6 as well as the schematic representations in FIGS. 9-12 and flow charts in FIGS. 7A-7C may be included, for example, on magnetic discs, optical discs such as compact discs, optical disc drives or other storage device or medium both those well known in the art as well as those yet to be devised. The storage mediums may contain the processing steps which are implemented using hardware to process images such as from telescopes or binoculars, or other optical systems and other images as well. These instructions may be in a format on the storage medium, for example, data compressed, that is subsequently altered.

Additionally, some or all the processing can be performed all on the same device, on one or more other devices that communicates with the device, or various other combinations. The processor may also be incorporated in a network and portions of the process may be performed by separate devices in the network. Display of the images such as the composite image or display of other information, e.g., a user interface, can be included on the device, can communicate with the devices, and/or communicate with a separate device.

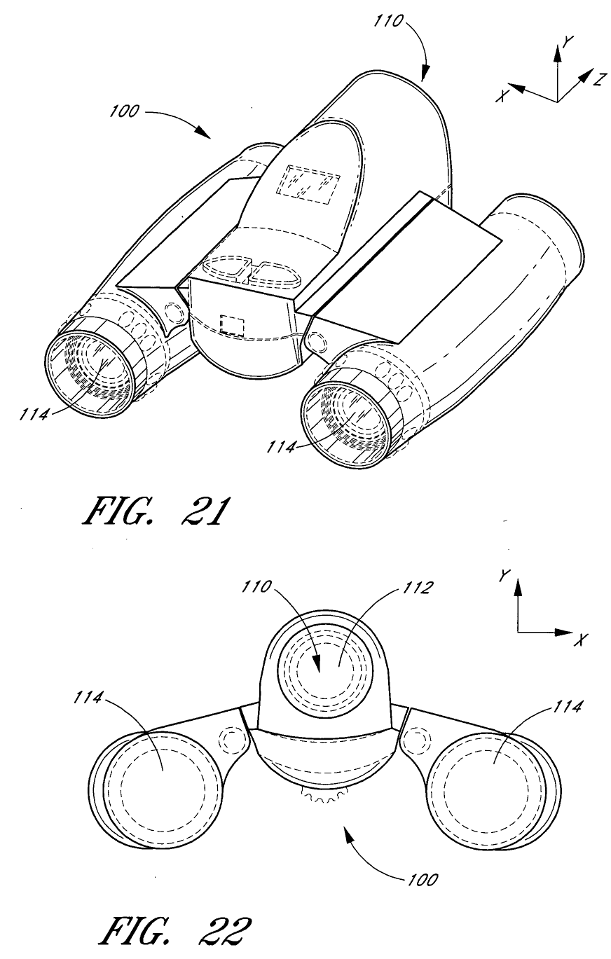

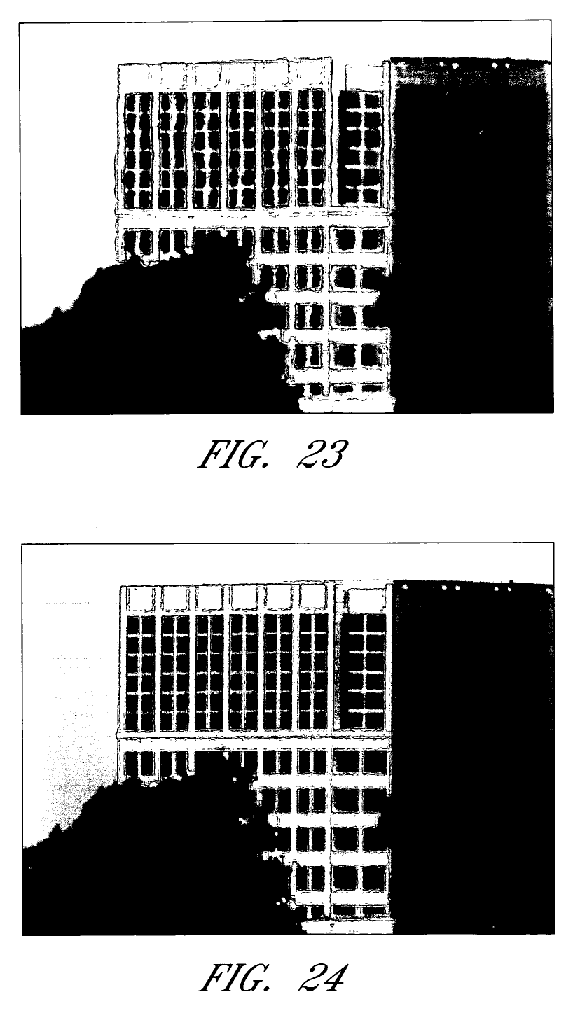

The structures and processes described above are not limited solely to use for astronomical applications. The image processor 18 and processing techniques can be used to reduce image blur for other imaging systems such as, for example, terrestrial telescopes and binoculars having an optoelectronic detector array. FIGS. 20-22 show various embodiments of binoculars 100 equipped with CMOS cameras 110. The binoculars 100 may comprise a pair of afocal optical imaging systems that provide a user with a magnified view, for example, of a terrestrial-based landscape or object. The binoculars 100 shown in FIGS. 20-22 further comprise CMOS cameras 110 for recording a similar image of the terrestrial object being viewed by the user. The magnification of the CMOS camera 110 is preferably about the same as the magnification of the binoculars, e.g., about 7 to 20× magnification, although the magnifications may be outside this range. As discussed above, the CMOS cameras 110 produce an electrical output yielding an electronic image.

In certain preferred embodiments, separate optical systems are employed for the user's eyes and the CMOS camera 110. The optics within the binoculars 100 may comprise a plurality of powered refractive optical elements (e.g., objective and ocular) and prisms for inverting the image. The CMOS camera 110 may also comprise refractive optical elements for forming an optical image on the CMOS detector array. As describe above, other detection devices, such as for example CCDs, may be employed. Other optical designs and configurations are also possible as described above. FIGS. 20 and 22 depict the optical systems 112, 114 for forming images on a CMOS detector array as well as the optical systems that direct optical images into the user's eyes. In other embodiments, however, the CMOS detector array may employ optics also used to form an optical image in the eye.

As discussed above, CMOS detectors arrays are substantially less expensive than CCD detector arrays. CMOS detectors, however, are also less sensitive. Accordingly, in low light conditions, such as for example dusk, indoors, artificial lighting, etc., these CMOS detectors have difficulty capturing high quality images.

Moreover, handheld binoculars suffer from anatomical vibration. The hands naturally have limited ability to hold the binoculars completely steady. As a result, the user holding the binoculars introduces movement into the optical system during the period over which the images are recorded. This movement is generally lateral movement (e.g., in the x and y directions) which is transverse to the optical axis (e.g., z-direction) of the optical systems. Such vibrations and other movements cause the CMOS camera 110 to capture a blurred image.

To reduce blur, the exposure time of the CMOS camera can be shorten such that the image is captured with a reduced amount of movement and vibration. For example, if an aperture is employed to control exposure of the detector array, the shutter can be opened for a shorter period of time during image capture. The images will therefore be under exposed. Shortening the exposure time limits the quantity of light and, thus, the image will be more faint as less light is collected by the CMOS detector array. As discussed above, however, the CMOS detector array is particularly susceptible to effects of low light levels.

To mitigate against these effects which otherwise degrade the image quality, a plurality of short exposure images is obtained. The exposure length is sufficiently short to reduce the effects of vibration. These exposure times, may for example range between about 1/5000 second to 1/100 second. For example, the exposure time may be between about 1/1000 and 1/100 second or between about 1/5000 and 1/1000 second. Exposure times outside these ranges, however, are possible. The number of images captured is preferably between about 10 to 50, such as between about 10 to 20 or 30 to 50, although more or less images may be obtained. To improve image quality, preferably at least a portion of these images are combined to form a composite image as described above.

As described for other image combination techniques, the plurality of images used to create the composite image are preferably selected from a larger set of images, the subset selected being of superior quality. Selection may be based, for example, on image content and/or compressibility, on the level of image degradation such as blurring or conversely on the level of clarity and contrast. Images with higher information content can be chosen. The compressibility may be used to determine the information content. As described above, images with higher contrast, those with more variation in signal magnitude from pixel to pixel, can also be chosen. Other images below a threshold level may be excluded from the subset of images combined to produce the higher quality composite image. Combining the images may comprise summing the magnitudes on a pixel-by-pixel basis. The aggregate magnitude may be scaled in some cases. In various embodiments, for example, the value of a given pixel in the composite image is the average of the magnitudes of the corresponding pixel in each of the images contained in the subset that is used to form the composite.

Prior to combining the images using any of the compositing processes described herein or other known processes, the images may be translated such that the common features in the image are substantially aligned. Translating the images preferably substantially removes the effects of movement of the features in the image over the period of time during which the plurality of images are obtained. Such movement may result for example from vibrations. Additional filtering may be employed to improve the quality of the image. This filtering may comprise contrast-enhancing filtering for increasing the contrast. In some embodiments, this filtering may be performed after the images have been combined to form the composite. This filtering is, however, optional.

Preferred embodiments of the structures and configuration of the imaging system are extensively discussed above. Some of the applicable structures include those shown in FIGS. 4 and 5. In one preferred embodiment, for example, the CMOS camera is electrically coupled to a computer via a USB connection as described above. In another preferred embodiment, the binoculars include RAM or other electronics, and image processing is performed in this RAM or other electronics. In such a configuration, the binoculars may also include a display and the processed image can be displayed on this display. The processed image can also be stored on a flash card or transferred to another component such as a computer through a data link such as, e.g., a USB port.

Preferred embodiments of the image processing techniques are also extensively discussed above. Some of these applicable processes are illustrated by FIGS. 6, 7A-7C, 8-12, and 25-28 and the discussions relating thereto. These processes can also advantageously be employed to improve the quality of the images obtained from the CMOS camera in the binoculars as well.

In one preferred embodiment, however, the region designated for quantitative analysis is presumed to be substantially located at the center of the field-of-view. A user is likely to orient the binoculars such that the object of interest is central. Accordingly, the region of interest is centrally located in certain preferred embodiments. Other approaches for determining the location of the region designated for analysis may be employed as well. As discussed above, evaluating the image over a smaller designated regions expedites processing.

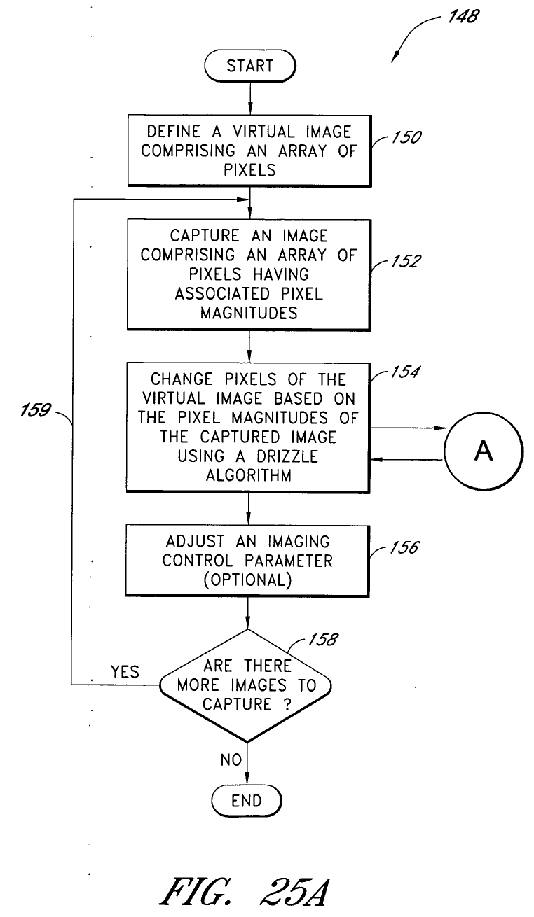

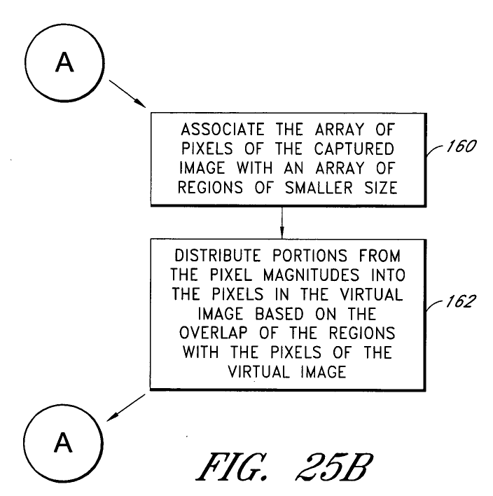

Further examples of the successful performance of the image processing described herein are shown in FIGS. 23 and 24. (The images in FIGS. 23 and 24, however, were not processed using a drizzle algorithm, which is discussed below.) FIG. 23 is an image of a terrestrial object obtained from a CMOS camera 110 incorporated in a pair of binoculars 100. This image exhibits noticeable blur. FIG. 24 is a composite image formed using an imaging processor and image processing techniques described herein. The composite image in FIG. 24 was formed from a plurality of blurred images similar to that shown in FIG. 23. The improved clarity provided by the image processor is readily discernible.

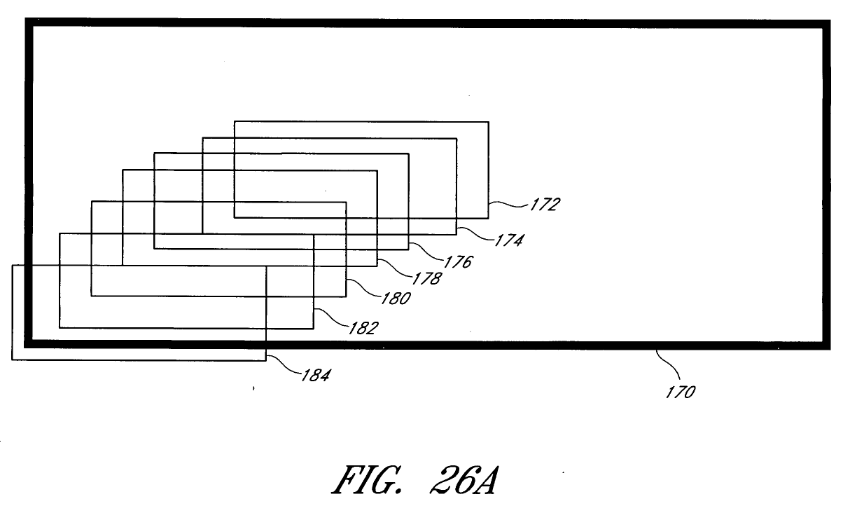

As described above, a drizzle algorithm may be employed in combining captured images into a composite. A detailed description of this method of forming a composite image is described with reference to FIGS. 25-33. FIG. 25 is a flow chart illustrating a process 148 of combining a plurality of images to form a composite image extending over an area of interest using a drizzle algorithm. An exemplary drizzle algorithm is described in “Drizzle: A Method for the Linear Reconstruction of Undersampled Images,” Publication of the Astronomical Society of the Pacific 114: 114-152, February, 2002.

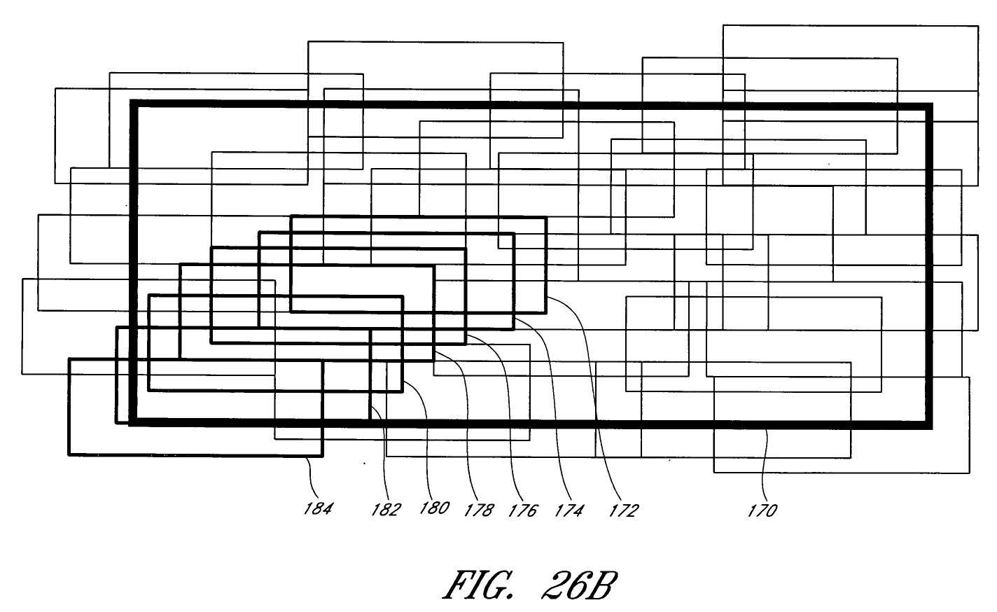

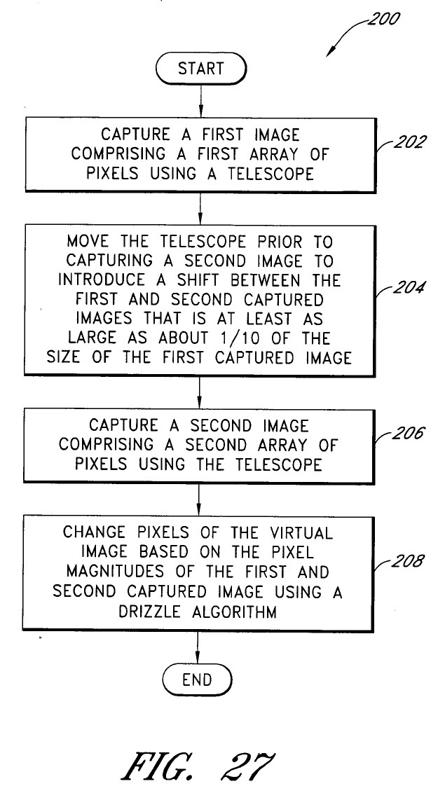

As illustrated in FIG. 25A, a virtual image is defined over an area of interest as exemplified in block 150. The area of interest, and thus the corresponding virtual image may be specified using, for example, a user interface (FIG. 8). As described above, this virtual image comprises an array of pixels. The process continues to block 152 where an image comprising an array of pixels is captured, using, for example, systems and methods described above. FIG. 26B illustrates the footprint of a defined virtual image 170 comprising pixels and a footprint of a first captured image 172 which also comprises pixels and encompasses at least a portion of the footprint of the virtual image 170. FIG. 26B also illustrates footprints of a plurality of images 174-184 captured subsequent to the first captured image 172. Captured images 174-184 also encompass at least a portion of the virtual image 170 and also comprise pixels. In one embodiment, a first image 172 is captured as a result of one pass through the process 148 and a second image 184 is captured after capturing a plurality of other images 174-182 during subsequent passes through the process 148 as shown by the loop 159. The pixels in the captured images 172-184 have an associated pixel magnitude and a defined spatial relationship such that pixels in the captured images 172-184 can be associated with pixels in the virtual image 170. The captured image can be evaluated for quality and if insufficient, the image can be improved using image processing techniques, or the image can be rejected.

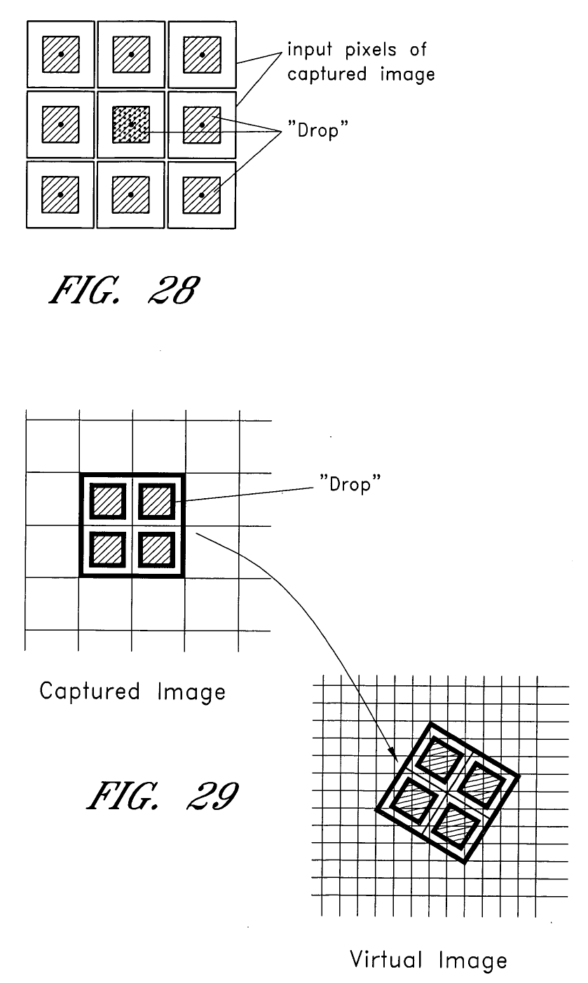

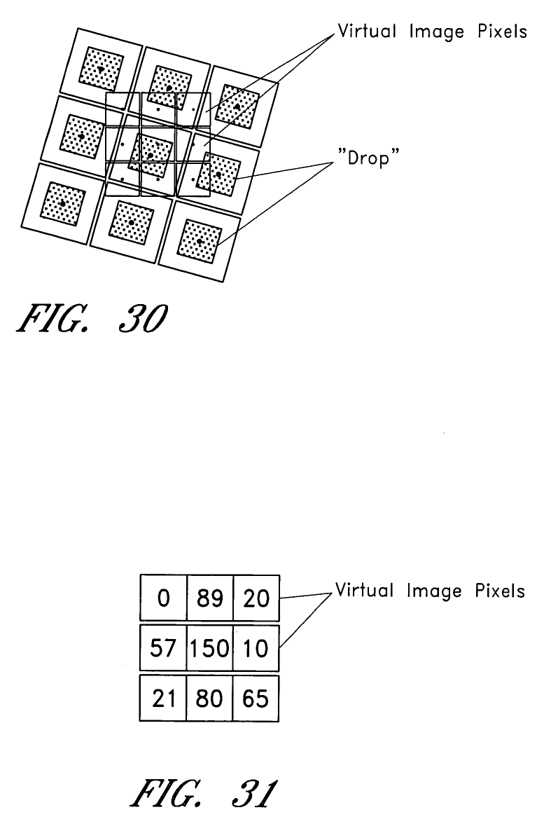

If the captured image has acceptable quality, the captured image 172 can be incorporated into the virtual image 170. Pixels of the virtual image 170 are then changed based on pixel magnitudes of the captured image using a drizzle algorithm, as represented by block 154. In the drizzle algorithm, known also as Variable-Pixel Linear Reconstruction (or “drizzling”), pixels in the captured images (input images) are mapped into pixels in the virtual image, taking into account shifts and rotations between the images and the virtual image 170 as illustrated in FIGS. 28 and 29. The pixels of the virtual image 170 are typically smaller than the pixels of the captured image. For example, the pixels in the virtual image 170 may be about one-half (½) the size of the pixels in the captured images to about the size of the pixels in the captured images, although other values smaller than one-half (½) the size of the pixels in the captured image are also possible. A higher resolution can therefore be obtained by mapping a plurality of captured images into the virtual image 170. To avoid convolving the image with the large pixel “footprint” of the detector array, the pixel is effectively “shrunk,” that is, the magnitude of the pixel in the captured image is associated with a smaller spatial region. This array of regions can also be referred to as shrunken pixels or as “drops.” FIG. 28 illustrates a 3 pixel×3 pixel portion of a captured image, and shows a drop defined for each pixel. As shown, the drop is smaller than the input pixel. The association of pixels of the captured image (input image) with an array of regions of smaller size is exemplified in block 160 of FIG. 25B.

Magnitude values are associated with each of the drops. In various preferred embodiments, for example, the drop has the same value as the pixel in the captured image to which the drop is associated. These magnitudes are distributed into pixel in the virtual image 170. The association of the drops with one or more pixels in the virtual image 170 is illustrated in FIG. 29. This association is based on the overlap of the drops with the pixels in the virtual image 170 after the captured images have be shifted and/or rotated where appropriate. As described above, reference features may be used to determine the suitable amount of translation and/or rotation. For example, the centroids of two reference points such as two stars may be used to compute the amount of shift in X and Y directions as well as the amount of rotation, the center of rotation, and the direction of rotation. One or both of these reference points may be changed, for example, in cases where the area of interest or virtual image 170 is so much larger than the captured images that some of the captured images do not include one or both the reference points. Other methods may also be employed.

As described above, the pixels in the virtual image 170 are typically reduced in size in comparison with the pixels in the captured images. The pixels in the virtual image 170 are also smaller than the drops in certain preferred embodiments. For example, the drops have linear dimensions one-half that of the input pixel, slightly larger than the dimensions of the pixels of the virtual image in some embodiments. The drops may range in size from between about one-fifth (⅕) as large as the pixels in the captured images to the same size as the pixels in the captured images, and between about one and two times the size of the pixels in the virtual image. Values outside these ranges are also possible.

Referring again to FIG. 25B, portions of the magnitudes of the pixels of the captured image are distributed into the pixels of the virtual image 170, based on the overlap of the drops (reduced regions) with the pixels of the virtual image. Accordingly, the drops may be said to “rain” down upon the corresponding pixels of the virtual image 170 disposed underneath; hence the name “drizzle”. In certain exemplary embodiments, for example, the pixel magnitude of each drop may be divided up among the overlapping virtual image 170 pixels in proportion to the areas of overlap between the pixels of the virtual image 170 and the drops of the captured image.

FIG. 30 illustrates the resulting overlap between drops and pixels of the virtual image 170, where a 3 pixel×3 pixel portion of the virtual image 170 is shown over-laid on a 3 pixel×3 pixel portion of captured image pixels. FIG. 31 illustrates one example of pixel magnitude values for the 3 pixel×3 pixel portion of the virtual image 170 shown in FIG. 30, where the magnitude values are based on values from 0-255 and correspond with the amount of overlap between the drops of the captured image and the pixels of the virtual image 170. These values are exemplary only and are not limiting. Note that if the drop size is too small not all output pixels in the virtual image 170 have data added to them from each input image. One of the pixels in the virtual image 170 shown in FIG. 30 has a zero value for this reason. Accordingly, the drop may be sized to be small enough to avoid degrading the image by convolution, yet large enough that the after all images are “dripped,” the coverage is fairly uniform and not disrupted zero values.

Referring again to FIG. 25A, in the process 148 one or more imaging, or telescope, control parameters can optionally be adjusted based on information from one or more of the previous images; see block 156. A control parameter can be adjusted in real time, for example, after the capture and analysis of one image and before the capture of a subsequent image. In some embodiments, the control parameter can be gain, DC offset, exposure time, focus, position, or another parameter which may or may not be used to capture the images with the imaging system 14. For example, to capture images to cover all portions of the virtual image 170 (FIG. 26A), the position parameter of the telescope can be adjusted to re-position the telescope after capturing an image so that a subsequent image includes at least a portion of the virtual image not captured by the previous image. FIG. 26A illustrates the footprint of a first captured image 172 captured at a first position that encompasses at least a portion of the virtual image 170. The first captured image 172 comprises pixels which correspond to pixels in the virtual image 170. FIG. 26A also illustrates footprints of images 174-184 which are captured after capturing the first image 172, where the telescope was repositioned to capture each of the images 174-184.

FIG. 26B illustrates the footprints of images 174-184 and numerous other captured images covering the virtual image 170, where the image capturing is facilitated by repositioning the telescope on another portion of the virtual image 170. To form a complete composite image, one or preferably more than one image is captured corresponding to every pixel in the virtual image 170. The addition of multiple images over any one portion of the virtual image 170 increases the information that can be provided to the drizzle algorithm for that portion of the area of interest. Using multiple images can result in a higher effective resolution and a reduction in correlated noise for the resulting composite image.

Referring again to FIG. 25A, process then determines if there are more images to capture, as represented by block 158. If images have been captured that encompass all of the virtual image 170, such as illustrated in FIG. 26B, the process may stop. Alternatively, if images have not been captured covering each portion of the virtual image 170, or if it is desirable to capture a plurality of images covering each portion of the virtual image 170, the process 148 follows loop 159 and continues to block 152, and where the process 148 captures one or more additional images. In some embodiments, additional images may be obtained even if the virtual image 170 is completely covered by different captured image, e.g., to reduce noise of the composite image. Also, in certain exemplary embodiments, the telescope 10 is not repositioned between captured images.

When images are combined using a drizzle algorithm, a weight map can be specified for each input image (e.g., containing information on bad pixels in the image). When the drizzle process generates the final virtual image 170 from all the captured images, it can also create an output weight map that combines information from all the input weights. For example, when a drop with value i_{xy} and user defined weight w_{xy} is added to an image with pixel value I_{xy}, weight W_{xy}, and fractional pixel overlap 0<a_{xy}<1, the resulting value of the image I′_{xy} and weight W′_{xy} is
W′_{xy}=a_{xy}w_{xy}+W_{xy}
I′_{xy}=(a_{xy}i_{xy}w_{xy}+I_{xy} W_{xy})/W′ₓ

FIG. 27 is a flow chart illustrating another process 200 of combining a plurality of images to form a composite image using a drizzle algorithm. In this process 200, a first image comprising a first array of pixels is captured using a telescope, such as the telescope 10 described in FIG. 5. This process 200 continues to block 204 where the telescope is moved prior to capturing a second image to introduce a shift between the first captured image and a second captured image that is at least as large as about 1/10 of the size of the first captured image. The process 200 then captures a second image comprising a second array of pixels using the telescope, as represented by block 206. The second image may correspond to the last image in certain embodiments. The second image referred to here can be captured immediately after the first image, or with a multiple other images captured in between the first and second images. The process 200 changes pixels of the virtual image 170 based on the pixel magnitudes of the first and second captured image using the drizzle algorithm, for example, as previously described.

Drizzle offers many advantages. Combining captured images using a drizzle algorithm or drizzle filtering preserves photometry and resolution. As discussed above, the drizzle approach takes into account the optical distortion of the camera. The drizzle filtering removes the effects of geometric distortion both on image shape and photometry, and increases the effective resolution. Additionally, the input images can be weighted according to the statistical significance of each pixel.

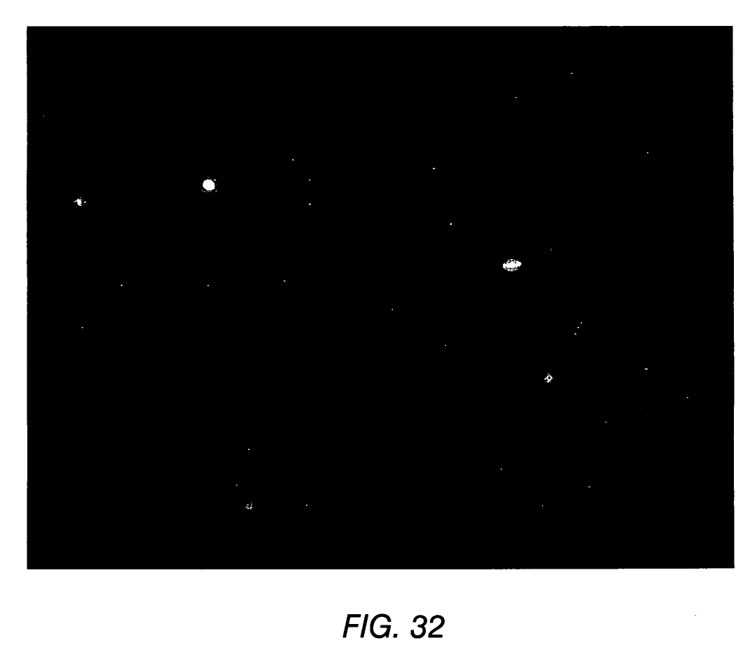

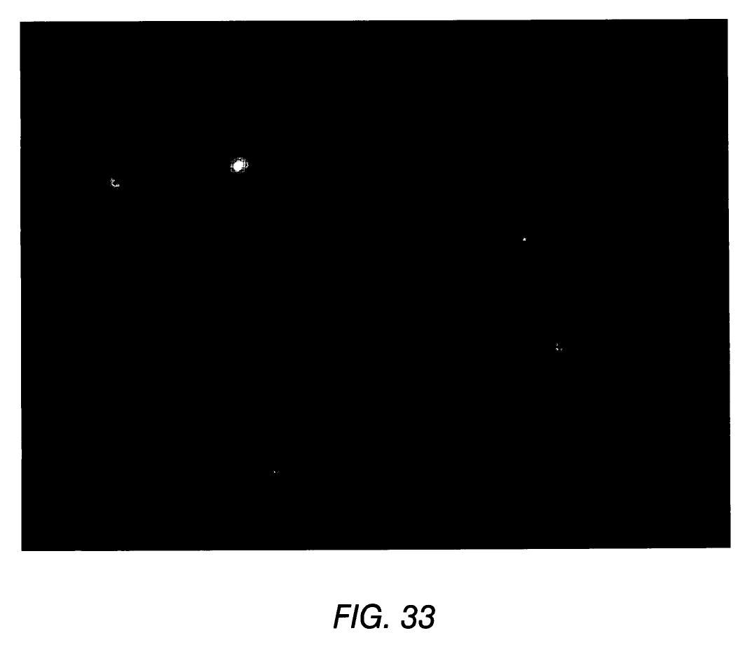

One example of image reconstruction using a drizzle algorithm is shown in FIGS. 32 and 33. FIG. 32 is a digital image of one captured image using a telescope system. FIG. 33 is a digital image of an image depicting the same image area as shown in FIG. 32 created using the drizzle algorithm and a plurality of images. The image of FIG. 33 appears to have less noise and shows a greater effective resolution, as faint objects not seen in the image of FIG. 32 are now visible in the image of FIG. 33.

Alternative approaches are also possible. For example, the processing steps may be interchanged and may be executed in different order or may be excluded or replaced altogether. Additional processing steps and features can also be added.

It will be appreciated by those skilled in the art that various omissions, additions and modifications may be made to the processes described above without departing from the scope of the invention, and all such modifications and changes are intended to fall within the scope of the invention, as defined by the appended claims.

What is claimed is:

1. A method of forming a virtual image by processing multiple images from a telescope, the virtual image comprising an array of pixels, the method comprising:
capturing an image comprising an array of pixels using the telescope, the pixels in the array of pixels having associated pixel magnitudes;
changing pixels of the virtual image based on the pixel magnitudes of the captured image using a drizzle algorithm;
adjusting an imaging control parameter after the changing step; and
repeating the capturing and changing steps after adjusting the imaging control parameter.

2. The method of claim 1, wherein the imaging control parameter is adjusted based on information from the captured image.

3. The method of claim 1, wherein the imaging control parameter is adjusted based on information from the virtual image.

4. The method of claim 1, wherein the pixels in the captured image have a larger size than the pixels in the virtual image.

5. The method of claim 4, wherein changing pixels of the virtual image using the drizzle algorithm comprises:
associating the array of pixels of the captured image with an array of regions of smaller size, respective pixel magnitudes for the array of pixels of the captured image being associated with corresponding regions in said array of regions; and
distributing portions from the pixel magnitudes into the pixels in the virtual image, the distribution being based on overlap of the regions with the pixels of the virtual image.

6. The method of claim 1, wherein the imaging control parameter comprises gain, DC offset, exposure time, focus, or position.

7. The method of claim 1, further comprising repositioning the telescope so that the captured image overlaps a portion of the virtual image that was not included in previously captured images.

8. The method of claim 7, wherein repositioning the telescope comprises positioning the telescope so that the captured image overlaps a portion of the virtual image that was included in previously captured images.

9. The method of claim 1, further comprising repositioning the telescope so that the captured image is translated an amount comprising more than twice the pitch of the pixels for the captured images.

10. The method of claim 9, wherein the telescope is translated an amount between about one-tenth ( 1/10) of a pixel and three-quarters (¾) of the size of the virtual image.

11. The method of claim 1, further comprising evaluating the quality of the captured image before including pixel magnitudes from the captured image in the virtual image.

12. The method of claim 1 1, wherein evaluating the quality of the captured image comprises comparing one or more characteristics of the captured image to one or more criteria, and rejecting the image if the one or more characteristics do not meet the corresponding criteria.

13. The method of claim 12, wherein the characteristic comprises sharpness, distortion, or smearing.

14. The method of claim 12, wherein one or more of the criteria are dynamically determined.

15. A telescope system for generating enhanced images, comprising:
a telescope;
a camera comprising a detector array disposed to capture images formed by the telescope, the captured images comprising arrays of pixels with associated pixel magnitudes; and
at least one processor in communication with the camera and the telescope, the processor configured to define a virtual image comprising pixels, receive a first captured image from the detector array, change pixels of the virtual image based on the pixel magnitudes of the first captured image using a drizzle algorithm, adjust an imaging control parameter after changing the pixels of the virtual image, receive a second captured image from the detector array, and change pixels of the virtual image based on the pixel magnitudes of the second captured image using a drizzle algorithm after adjusting the imaging control parameter.

16. The system of claim 15, wherein the processor is further configured to reposition the telescope using information from the first captured image to determine the position of the telescope for the second captured image.

17. The system of claim 15, wherein the processor is further configured to evaluate the captured image before including pixel magnitudes from the captured image in the virtual image.

18. A method of forming an enlarged virtual image by processing multiple images from a telescope, the enlarged virtual image comprising an array of pixels, the method comprising:
capturing a first image comprising a first array of pixels using the telescope, the pixels in the first array of pixels having respective pixel magnitudes;
capturing a second image comprising a second array of pixels using the telescope, the pixels in the second array of pixels having respective pixel magnitudes;
moving the telescope prior to capturing the second image to introduce a shift between the first and second captured images that is at least as large as about 1/10 of the size of the first captured image; and
changing pixels of the virtual image based on the pixel magnitudes of the first and second captured image using a drizzle algorithm.

19. The method of claim 18, wherein the telescope is moved such that the second captured image is shifted by at least about one-tenth ( 1/10) to about ten (10) times the size of the first captured image.

20. The method of claim 18, further comprising moving the telescope and capturing images a plurality of times prior to capturing the second image.

21. The method of claims 18, wherein the telescope is moved and images are captured between 1 and 100 times after capturing the first image and prior to capturing the second image.

22. The method of claim 20, wherein the first array of pixels have a pixel pitch, and the telescope is moved sufficiently to provide a shift between captured images at least as much as about twice the pixel pitch.

23. The method of claim 20, wherein the enlarged virtual image is at least about 100 to 1000 percent as large at the first captured image.

24. The method of claim 18, wherein the virtual image is changed based on the pixel magnitudes of the first captured image prior to capturing the second image.

25. A telescope system for generating enhanced images, comprising:
a telescope including a movable positioning system;
a camera comprising a detector array disposed to capture images formed by the telescope, the captured images comprising arrays of pixels with associated pixel magnitudes; and
at least one processor in communication with the detector array and positioning system, the processor configured to define a virtual image comprising pixels, capture a first image, capture a second image, move the telescope prior to capturing the second image to introduce a shift between the first and second captured images that is at least as large as about 1/10 of the size of the first captured image, and change pixels of the virtual image based on the pixel magnitudes of the first and second captured image using a drizzle algorithm.

26. A system that produces a virtual image by processing multiple images from a telescope, the virtual image comprising an array of pixels, the system comprising:
means for capturing an image formed by the telescope, the image comprising an array of pixels having a pixel magnitude;
means for changing pixels of the virtual image based on the pixel magnitudes of the captured image using a drizzle algorithm; and
means for adjusting an imaging control parameter after changing pixels of the virtual image,
wherein said means for capturing and said means for changing are configured to repeat the capturing and changing steps after adjustment of the imaging control parameter.

27. A computer-readable storage medium containing a set of instructions for a computer for forming a virtual image by processing multiple images from a telescope, the virtual image comprising an array of pixels, the set of instructions comprising:
capturing an image comprising an array of pixels using the telescope, the pixels in the array of pixels having respective pixel magnitudes;
changing pixels of the virtual image based on the pixel magnitudes of the captured image using a drizzle algorithm;
adjusting an imaging control parameter after changing pixels of the virtual image; and
repeating the capturing and changing steps after adjusting the imaging control parameter.
